(19) United States
(12) Patent Application Publication
(10) Pub. No.: US 2014/0189152 A1
(43) Pub. Date: Jul. 3, 2014

(54) Methods, Systems, and Computer Program Products for Identifying a Protocol Address based on Path Information

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/727,647

(22) Filed: Dec. 27, 2012

(51) Int. Cl. H04L 12/56

(52) U.S. Cl. CPC H04L 45/02
USPC 709/238

(57) ABSTRACT

Methods and systems are described for identifying a protocol address based on path information. In an aspect, first path information is detected that identifies a first sequence of nodes in a first network path for transmitting data between a first node and a second node in a network. Second path information is detected that identifies a second sequence of nodes in a second network path for transmitting data between the second node and a third node in the network. A first-third protocol address is determined, based on the first path information and the second path information, that identifies, according to a network protocol, the third node to the first node for communicating via the network protocol.

### RELATED APPLICATIONS

This application is related to the following commonly owned, pending U.S. patent applications, by the present inventor, the entire disclosures being incorporated by reference herein:

Application Ser. No. 13/727,649 (Docket No DRV0026) filed on 2012 Dec. 27, entitled “Methods, Systems, and Computer Program Products for Assigning an Interface Identifier to a Network Interface”;

Application Ser. No. 13/727,651 (Docket No DRV0027) filed on 2012 Dec. 27, entitled “Methods, Systems, and Computer Program Products for Routing Based on a Nested Protocol Address”;

Application Ser. No. 13/727,652 (Docket No DRV0028) filed on 2012 Dec. 27, entitled “Methods, Systems, and Computer Program Products for Routing Based on a Scope-specific Address Space”;

Application Ser. No. 13/727,653 (Docket No DRV0029) filed on 2012 Dec. 27, entitled “Methods, Systems, and Computer Program Products for Identifying a Protocol address in a Scope-specific Address Space”;

Application Ser. No. 13/727,655 (Docket No DRV0030) filed on 2012 Dec. 27, entitled “Methods, Systems, and Computer Program Products for Determining a Shared identifier for a Hop in a Network”;

Application Ser. No. 13/727,657 (Docket No DRV0031) filed on 2012 Dec. 27, entitled “Methods, Systems, and Computer Program Products for Determining a Hop Identifier for a Network Protocol”; and

Application Ser. No. 13/727,662 (Docket No DRV0032) filed on 2012 Dec. 27, entitled “Methods, Systems, and Computer Program Products for Routing Based on a Path-Based Protocol Address”.

### BACKGROUND

It is unlikely that the designers of the early network, which is referred to as the “Internet”, expected it to become as large as it has become. The fact that the global Internet Protocol (IP) address space, for 32-bit addresses, has been fully allocated is evidence of this. As the Internet grows, new problems will arise and some current problems are getting worse. For example, while network speeds and bandwidth are increasing, so are causes of network latency.

The Internet Engineering Task Force (IETF) has taken steps at various times in the past and are presently taking steps to address a number of problems resulting from the Internet's growth. Problems addressed by the IETF are described in a number of “Request for Comments” (RFC) documents published by the IETF. Documents referenced herein and included by reference include: “Request for Comments” (RFC) document RFC 791 edited by J. Postel, titled ““Internet Protocol, DARPA Internet Protocol Specification”, published by the IETF in September, 1981;

“Request for Comments” (RFC) document RFC 1519 by V. Fuller, et al, titled “Classless Inter-Domain Routing (CIDR): An Address Assignment and Aggregation Strategy”, published by the Internet Engineering Task Force (IEFT), in June, 1999;

“Request for Comments” (RFC) document RFC 2460 by S. Deering, et al, titled “Internet Protocol, Version 6, (IPv6) Specification”, published by the IETF in December, 1998;

“Request for Comments” (RFC) document RFC 3513 by R. Hinden, et al, titled ““Internet Protocol Version 6 (IPv6) Addressing Architecture”, published by the IETF in April, 2003; and

“Request for Comments” (RFC) document RFC 2374 by R. Hinden, et al, titled ““Aggregatable Global Unicast Address Format”, published by the IETF in July, 1998.

RFC 791 states, “The internet protocol implements two basic functions: addressing and fragmentation”. RFC 791 goes on to state, “A distinction is made between names, addresses, and routes. A name indicates what we seek. An address indicates where it is. A route indicates how to get there. The internet protocol deals primarily with addresses. It is the task of higher level (i.e., host-to-host or application) protocols to make the mapping from names to addresses. The internet module maps internet addresses to local net addresses. It is the task of lower level (i.e., local net or gateways) procedures to make the mapping from local net addresses to routes”.

As demonstrated by the RFCs listed above addressing has been a source of a number of problems. In order to address a number of current and future problems facing the Internet, the subject matter described herein challenges the distinctions asserted in RFC 791 and establishes new relationships between and among names, addresses, and routes. The description herein further demonstrates that current internet addresses do not indicate where a node or network interface component (NIC) of a node is. They provide another global identifier space for identifying nodes and their network interfaces. This global identifier space to some extent is duplicative of the domain name space that is also a global identifier space for identifying nodes and network interfaces. This duplication of roles is unnecessary as described below.

Accordingly, there exists a need for methods, systems, and computer program products for identifying a protocol address based on path information.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for identifying a protocol address based on path information. In one aspect, the method includes detecting first path information that identifies a first sequence of nodes in a first network path for transmitting data between a first node and a second node in a network. The method further includes detecting second path information that identifies a second sequence of nodes in a second network path for transmitting data between the second node and a third node in the network. The method still further includes determining, based on the first path information and the second path information, a first-third protocol address that identifies, according to a network protocol, the third node to the first node for transmitting data from the first node to the third node. Performing at least one element identified as included in the method includes execution of an instruction by a processor.

Further, a system for identifying a protocol address based on path information is described. The system includes a path detector component operable for and/or otherwise included in detecting first path information that identifies a first sequence of nodes in a first network path for transmitting data between a first node and a second node in a network. The system further includes an address space director component operable for and/or otherwise included in detecting second path information that identifies a second sequence of nodes in a second network path for transmitting data between the second node and a third node in the network. The system still further includes a path composer component operable for and/or otherwise included in determining, based on the first path information and the second path information, a first-third protocol address that identifies, according to a network protocol, the third node to the first node for transmitting data from the first node to the third node. The system also includes a processor, wherein at least one of the path detector component, the address space director component, and the path composer component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for identifying a protocol address based on path information according to an aspect of the subject matter described herein;

FIG. 3 is a block diagram illustrating an arrangement of components for identifying a protocol address based on path information according to another aspect of the subject matter described herein;

FIG. 4A is a block diagram illustrating an arrangement of components for identifying a protocol address based on path information according to another aspect of the subject matter described herein;

FIG. 4B is a block diagram illustrating an arrangement of components for identifying a protocol address based on path information according to another aspect of the subject matter described herein;

FIG. 5A is a network diagram illustrating an exemplary system for identifying a protocol address based on path information according to another aspect of the subject matter described herein;

FIG. 5B is a network diagram illustrating an exemplary system for identifying a protocol address based on path information according to another aspect of the subject matter described herein;

FIG. 5C is a network diagram illustrating an exemplary system for identifying a protocol address based on path information according to another aspect of the subject matter described herein;

FIG. 6A is a diagram illustrating an exemplary representation of a protocol address based on path information according to another aspect of the subject matter described herein;

FIG. 6B is a diagram illustrating an exemplary representation of a protocol address based on path information according to another aspect of the subject matter described herein;

FIG. 6C is a diagram illustrating an exemplary representation of a protocol address based on path information according to another aspect of the subject matter described herein;

FIG. 6D is a diagram illustrating an exemplary representation of a protocol address based on path information according to another aspect of the subject matter described herein;

FIG. 6E is a diagram illustrating an exemplary representation of a protocol address based on path information according to another aspect of the subject matter described herein;

FIG. 7A is a data exchange diagram illustrating messages exchanged between nodes in another aspect of the subject matter described herein;

FIG. 7B is a data exchange diagram illustrating messages exchanged between nodes in another aspect of the subject matter described herein; and

FIG. 7C is a data exchange diagram illustrating messages exchanged between nodes in another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments and/or aspects may be utilized and structural and functional modifications may be made without departing from the scope of the subject matter disclosed herein.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided to”, “received from”, “identified to”, “interoperated” and similar terms and their variants.

As used herein, any reference to an entity “in” an association is equivalent to describing the entity as “included in and/or identified by” the association, unless explicitly indicated otherwise.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

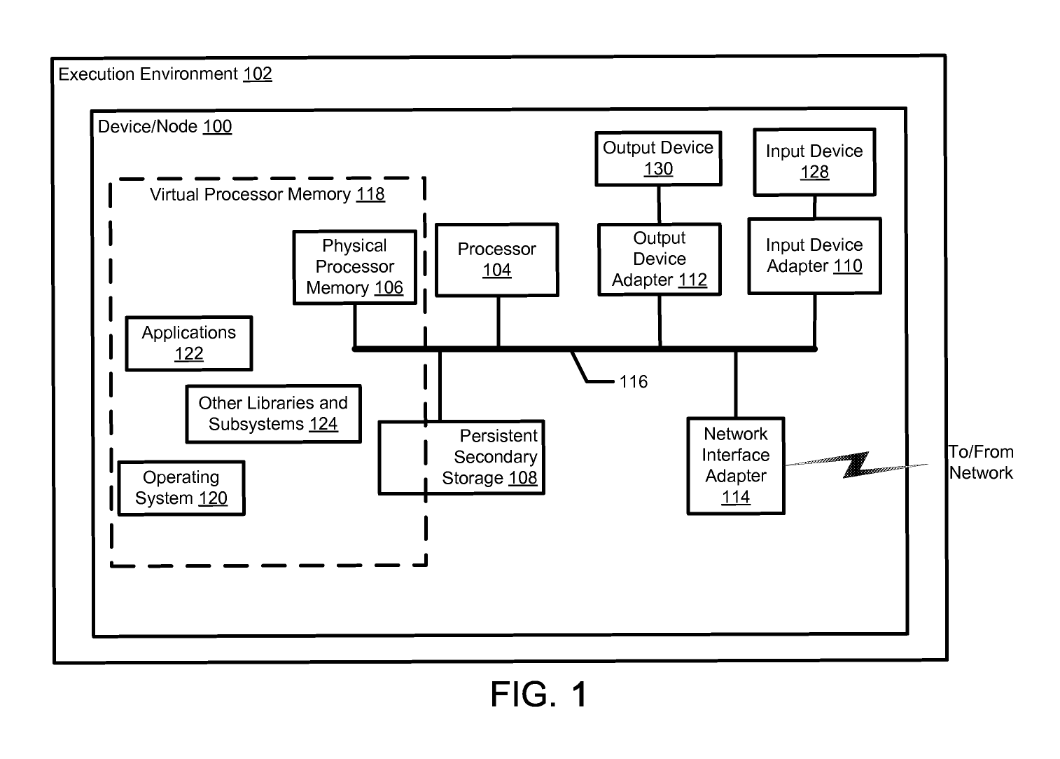

An exemplary device included in an execution environment that may be programmed, adapted, modified, and/or otherwise configured according to the subject matter is illustrated in FIG. 1. An “execution environment”, as used herein, is an arrangement of hardware and, in some aspects, software that may be further modified, transformed, and/or otherwise configured to include and/or otherwise host an arrangement of components to perform a method of the subject matter described herein. An execution environment includes and/or is otherwise provided by one or more devices. The execution environment is said to be the execution environment “of” the device and/or devices. An execution environment may be and/or may include a virtual execution environment including software components operating in a host execution environment. Exemplary devices included in and/or otherwise providing suitable execution environments that may be adapted, programmed, and/or otherwise modified according to the subject matter include a workstation, a desktop computer, a laptop or notebook computer, a server, a handheld computer, a mobile telephone or other portable telecommunication device, a media playing device, a gaming system, a tablet computer, a portable electronic device, a handheld electronic device, a multiprocessor device, a distributed system, a consumer electronic device, a router, a network server, or any other type and/or form of computing, telecommunications, network, and/or media device that is suitable to perform the subject matter described herein. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for computer-executable instructions, data structures, program components, and other data.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 may receive input and provide a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component. Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., AMPS, TDMA, CDMA, GSM, GPRS UMTS, and/or PCS network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A “user interface (UI) element handler” component, as the term is used herein, refers to a component that operates to send information representing a program entity to present a user-detectable representation of the program entity by an output device, such as a display. A “program entity” is an object, such as a variable or file, included in and/or otherwise processed by an application or executable. The user-detectable representation is presented based on the sent information. Information that represents a program entity to present a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send information representing one or more program entities to present particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

An “interaction”, as the term is used herein, refers to any activity including a user and an object where the object is a source of sensory data detected by the user and/or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is receiving sensory information from the portable electronic. An interaction may include an input from the user that is detected and/or otherwise sensed by the device. An interaction may include sensory information that is received by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect a user's head turn in the direction of a display of a portable electronic device. Interaction information indicating that the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus, the interaction information may serve as interaction information for one or more different objects.

As used herein, the terms “program” and “executable” refer to any data representation that may be and/or may be translated into a set of machine code instructions and may optionally include associated program data. The terms are used interchangeably herein. Program representations other than machine code include object code, byte code, and source code. Object code includes a set of instructions and/or data elements that either are prepared to link prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. A program and/or executable may include one or more components, referred to herein as a “program component”, a “software component”, and/or an “executable component”. As used herein, the terms “application”, and “service” may be realized in one or more program components and/or in one or more hardware components.

As used herein, the term “network protocol” refers to a set of rules, conventions, and/or schemas that govern how nodes exchange information over a network. The set may define, for example, a convention and/or a data structure. The term “network path” as used herein refers to a sequence of nodes in a network that are communicatively coupled to transmit data in one or more data units of a network protocol between a pair of nodes in the network.

A “data unit”, as the term is used herein, is an entity specified according to a network protocol to transmit data between a pair of nodes in a network path to send the data from a source node to a destination node that includes an identified protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting an IP packet that defines a header to identify a destination address that identifies a destination node and a payload portion to include a representation of data to be delivered to the identified destination node. Various address types are specified defining a vocabulary for one or more address portions of an IP data unit. The terms “data unit”, “frame”, “data packet”, and “packet” are used interchangeably herein. One or more data units of a first network protocol may transmit a “message” of a second network protocol. For example, one or more data units of the IP protocol may include a TCP message. In another example, one or more TCP data units may transmit an HTTP message. A message may be empty.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units to transmit to a next node in the network path. Portions of data received in several data units may be combined into a single data unit to transmit by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the network protocol. For example, 192.168.1.1 is an IP protocol address represented in a human readable format that may be represented in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

A node in a pair of nodes in a network path at one end of the sequence of nodes in the network path and/or the other end is referred to herein as a “path end node”. Note that a node may have two NICs with one NIC at each end of a network path. A network path may be included as a portion of another network path that communicatively couples a same pair of nodes. Data may be transmitted via the sequence of nodes in a network path between path end nodes communicatively coupled via the network path. Data may be transmitted in one or both directions depending on an ordering of the nodes in the sequence.

The term “hop” as used herein refers to a pair of consecutive nodes in a network path to transmit, via a network protocol, data sent from a source node to a destination node. A “hop path” is thus a sequence of hops in a network that respectively include a sequence of pairs of consecutive nodes included in transmitting data from a first path end node of the network path to a second path end node of the network path.

The term “path-based protocol address” as used herein refers to a protocol address for a network protocol that includes one or more path segment identifiers that identify one or more respective portions of a network path identified by the path-based protocol address. A “node-based protocol address” is a path-based protocol address that includes a plurality of node identifiers that identify a sequence of nodes in a network path. A “network-interface-based protocol address” is a path-based protocol address that includes a plurality of interface identifiers that identify a sequence of network interfaces in a network path. A “NIC-based protocol address” is a type of network-interface-based protocol address that includes a plurality of identifiers that identify a sequence of network interface components. A “hop-based protocol address” is a type path-based protocol address since a hop is a type of network path.

Given the above definitions, note that the terms “network path” and “hop” may be defined in terms of network interfaces. A “network path” and a “hop path” include a sequence of network interfaces in a network that are included in transmitting data between a pair of path end nodes in the network. A “hop” refers to at least part of a network path that includes a pair of consecutive network interfaces in a sequence of network interfaces in a network path. A “network path” is thus a sequence of hops in a network that respectively includes a sequence of pairs of consecutive network interfaces included in transmitting data from a first path end node of the network path to a second path end node of the network path.

The term “network topology” or “topology”, for short, as used herein refers to a representation of protocol endpoints and/or nodes in a network, and representations of hops representing communicative couplings between and/or among the protocol endpoints and/or nodes in the network. A network may have different network topologies with respect to different network protocols. A network topology may represent physical communicative couplings between nodes in the network. A network topology may represent logical couplings between protocol endpoints and/or nodes of a particular network protocol or a particular type of network protocol.

The domain name system (DNS) of the Internet operates based on an application layer protocol defined by the DNS. The nodes in the DNS are communicatively coupled via the DNS protocol and may be represented by a logical network topology. A DNS system includes nodes connected via the DNS protocol. The DNS system has a network topology defined by nodes that include protocol endpoints of the DNS protocol. In still another example, a token-ring network has a circular topology at the link layer, but may have a star topology at the physical layer.

As used herein, an “entity-specific address space” refers to an address space defined for a specific entity where the addresses in the address space operate as identifiers in the context of the entity. An address from an entity-specific address space is referred to herein as an “entity-specific address”. An address is “entity-specific” in that what it identifies is based on the entity to which it is specific. Another address having the same form and content may identify a different entity when in an address space specific to another entity. Addresses in an entity-specific address space operate as identifiers in the context of an entity to which they are “specific” as defined by the specific association of the address space and the entity. Without knowledge of the entity to which an entity-specific address space is specific, what an address in the entity-specific address space identifies is indeterminate. The terms “entity-specific address” and “entity-specific identifier” are used interchangeably herein. An entity-specific address may identify an entity included in the entity to which the address is specific or may identify an entity external to the entity to which the address is specific. The fact that an address is entity-specific does not define a scope for the address.

A portion of a network is a type of entity. A type of entity-specific address space described herein is a scope-specific address space. As used herein, a “scope-specific address space”, specific to a particular region of a network, is an address space defined for the particular network region, where an address in the scope-specific protocol address operates as identifier, according to a network protocol, of a protocol endpoint in a node outside of the particular region when processed in the context of a node in the particular region. The region is indicated by the span of an indicated scope. The terms “region” and “zone” are used interchangeably herein. An address from a scope-specific address space is referred to herein as a “scope-specific protocol address”. An address is “scope-specific” in that what protocol endpoint it identifies depends on the region to which it is specific. Another address having the exact same form and content may identify a different protocol endpoint when in an address space that is specific to another region. A protocol address in a scope-specific address space serves as an identifier in the context of a node in a region to which the scope-specific address space is “specific” as defined by an association of the address space and the region indicated by the scope. Without knowledge of the particular region to which a scope-specific address space is specific, what a scope-specific protocol address in the scope-specific address space identifies is indeterminate. The terms “scope-specific protocol address” and “scope-specific protocol identifier” are used interchangeably herein. Types of scope-specific address spaces indicating exemplary spans include site-specific, LAN-specific, subnet-specific, city-specific, business-specific, and node-specific.

For a network protocol, an address in a scope-specific address space serves as an identifier of a protocol endpoint in a node. Data may be received via the protocol endpoint from a network via one or more network interfaces that operatively couple the node to the network. Data may be sent via the protocol endpoint to transmit over the network via the one or more network interfaces in the node. Since a protocol endpoint of a network protocol is included in a node and is accessible via a network via a network interface, a protocol address identifying the protocol endpoint also identifies the node and identifies a network interface of the node.

As used herein, a “node-specific address space” is a scope-specific address space defined for a specific node in a network, where the addresses in the node-specific address space operate as identifiers of nodes and/or network interfaces in the network when processed in the context of the specific node. An address from a node-specific address space is referred to herein as a “node-specific address”. An address is “node-specific” in that what it identifies depends on the node to which is defined as specific. Another address having the exact same form and content may identify a different node when in an address space specific to another node. Addresses in a node-specific address space operate as identifiers in the context of a node to which they are “specific” as defined by the specific association of the address space and the node. Without knowledge of the node to which a node-specific address space is specific, addresses in the node-specific address space are indeterminate. The terms “node-specific address” and “node-specific identifier” are used interchangeably herein. A node-specific address space is a type of scope-specific address space.

The term “node” is defined above. Note that an identifier of a network interface in a network also identifies a node that includes the network interface. Thus, a network interface-specific address is also a node-specific address. Network interfaces in a node may have their own respective network interface-specific address spaces that are also node-specific. The network interface-specific address spaces may be combined to form a node-specific address space and/or may be managed as separate address spaces. The adjectives “node-specific” and “network interface-specific” may be used interchangeably.

A scope-specific identifier differs from a scoped address as described in “Request for Comments” (RFC) document RFC 4007 by S. Deering, et al, titled “IPv6 Scoped Address Architecture”, published by the IETF in December, 2006 and further described in application Ser. No. 11/962,285, by the present inventor, filed on 2007 Dec. 21, entitled “Methods and Systems for Sending Information to a zone Included in an Internet Network”. A scoped address space is shared by nodes in a given scope. While a link-local scoped address is specific to a particular node, a link-local scoped address simply identifies a network interface component local to the particular node. A loop-back internet address is specific to a node as well. Neither link-local scoped addresses nor loop-back addresses identify one node to another. As such, neither serves as a node-specific identifier as defined above.

A “scoped address” is described by RFC 3513 and RFC 4007 as an identifier that, in a particular region of a network, serves as a protocol address of a network interface and/or a node in the particular region. The extent of the particular region is referred to as the scope of the region and thus the scope within which the identifier serves as a protocol address. A particular region included within a scope is indicated by its span. A scoped address is a valid protocol address only within a particular region as indicated by the address's indicated scope. Examples of scope indicators include node-scope where identifiers are valid only to a single node in the indicated span, LAN-scope where identifiers are valid for nodes in the span of a particular LAN, and subnet-scope where identifiers are valid only for nodes in a particular subnet. RFC 3513 currently defines support for link-local scope, site-local scope, and global scope. A data unit transmitted with a scoped address should not be delivered to node that does not have a network interface in the span indicated by the scope.

“Path information” is any information that identifies a network path and/or a hop path for data transmitted via one a specified network protocols. Path information may be identified by identifying network interfaces, NICs, nodes, and/or hops included in a network path. “Address information” is any information that identifies a protocol address that, for a network protocol, identifies a protocol endpoint. Address information may identify a unicast protocol address for a network protocol. In identifying a protocol endpoint, a protocol address identifies a node and a network interface.

Those skilled in the art will understand upon reading the descriptions herein that the subject matter disclosed herein is not restricted to the network protocols described and/or their corresponding OSI layers. For ease of illustration, the subject matter is described in terms of protocols that correspond to OSI layer three, also referred to as network layer protocols, in general. Particular descriptions are based on versions of the Internet Protocol (IP). Address information may identify one or more protocol addresses. Exemplary protocol addresses include IP addresses, IPX addresses, DECNet addresses, VINES Internet Protocol addresses, and Datagram Delivery Protocol (DDP) addresses, HTTP URLS, TCP port and IP address pairs, and the like.

The term “path-based address” is defined above. A “node-based address” is a path-based address where some or all of the address includes node identifiers that identify a sequence of nodes in a network path. A “network-interface-based address” is a path-based address where some or all of the address includes identifiers of network interfaces in a sequence in a network path. A “NIC-based address” is a type of network-interface-based address that identifies a sequence of network interface components. A “hop-based address” is a path-based address where some or all of the address identifies one or more hops in a network path. The protocol address types defined are not mutually exclusive.

The term “metric space”, as used herein, refers to a set, as defined in mathematics, where a distance between elements of the set is defined according to a metric. Metric spaces defined in Euclidean geometry are well-known examples. Those skilled in the art of metric spaces, such as Euclidian spaces, will appreciate that a one-to-one mapping may be determined and/or otherwise identified for mapping addresses from a first coordinate space having a first origin for a metric space to addresses from a second coordinate space having a second origin in the metric space. Given a mapping rule between a first scope-specific address space and a second scope-specific address space and a mapping between the second scope-specific address space and a third scope-specific address space based on a third coordinate space identifying a third origin in the metric space, a mapping from the first coordinate space to the third coordinate space may be determined. A mapping between coordinate spaces for a metric space may be included a coordinate shift and/or a rotation, for example. The mapping may be pre-specified and accessible to the nodes in one or both address spaces. Mapping between locations in a number of different metric spaces is well known in mathematics. For example, a top half of the surface of sphere may be mapped to a plane. Some will further appreciate that some metric spaces may be mapped to other metric spaces. Some of these mappings are one-to-one and/or onto.

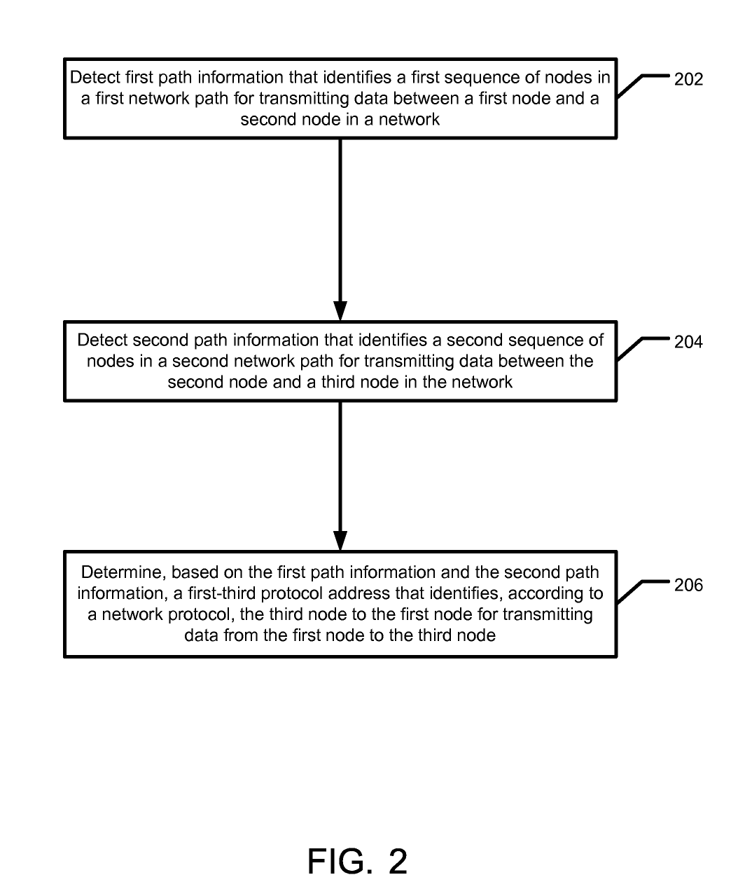

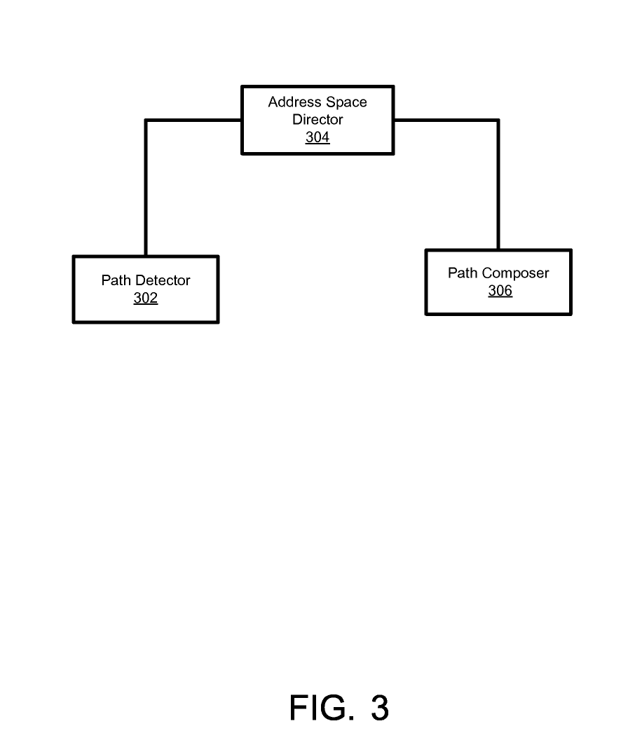

FIG. 3 illustrates an arrangement of components in a system, that operates in an execution environment, such as execution environment 102 in FIG. 1. The arrangement of components in the system operates to perform the method illustrated in FIG. 2. The system illustrated includes a path detector component 302, an address space director component 304, and a path composer component 306. A suitable execution environment includes a processor, such as processor 104, to process an instruction in at least one of the path detector component 302, the address space director component 304, and the path composer component 306.

Some components, illustrated in the drawings are identified by numbers with an alphanumeric suffix. A component may be referred to generically in the singular or the plural by dropping a suffix of a portion thereof of the component's identifier. For example, execution environments, such as an adaptation, analog, and/or instance of execution environment 401a are referred to herein generically as an execution environment 401 or execution environments 401 when describing more than one. Other components identified with an alphanumeric suffix may be referred to generically or as a group in a similar manner.

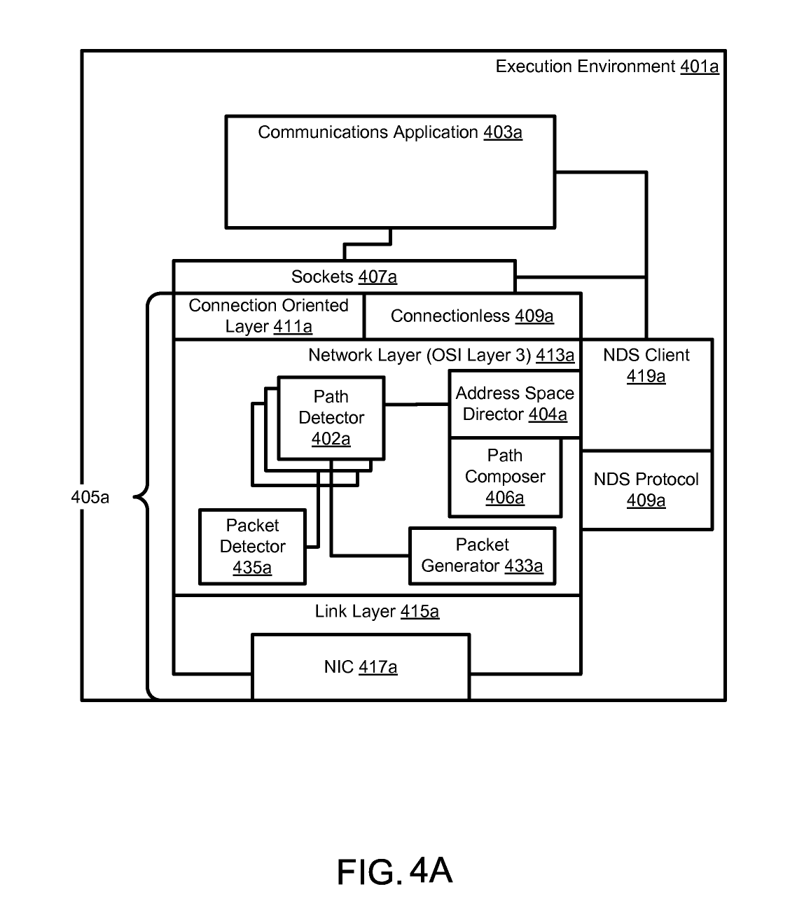

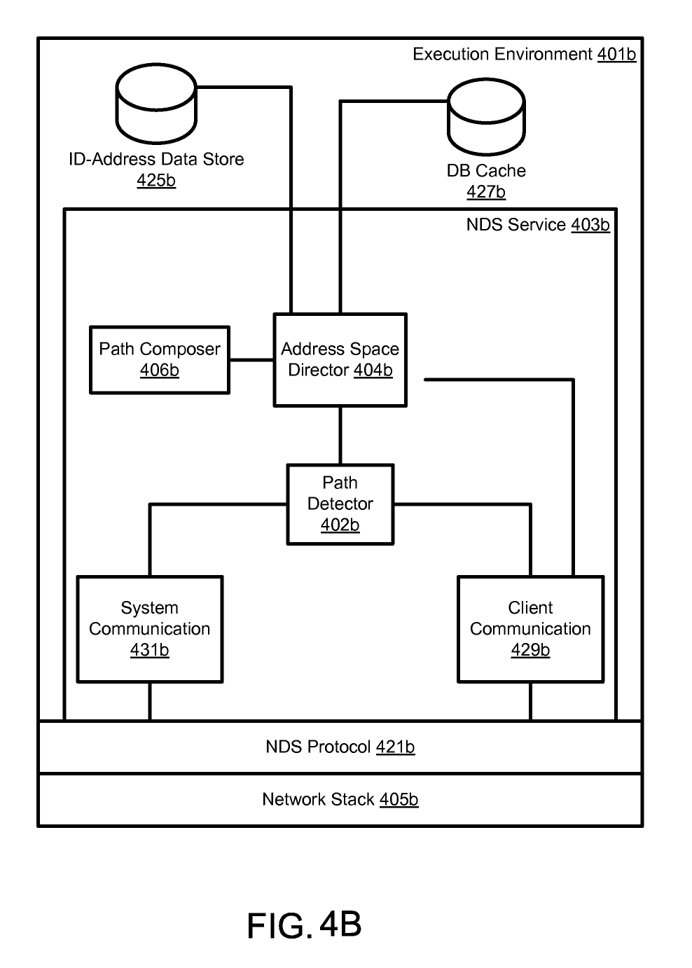

Some or all of the exemplary components illustrated in FIG. 3, their adaptations, and/or their analogs may operate in a number of execution environments to perform the method illustrated in FIG. 2. FIGS. 4A-B are each block diagrams illustrating the components of FIG. 3 and/or analogs of the components of FIG. 3 respectively adapted to operate in an execution environment 401a and an execution environment 401b that each include and/or otherwise are provided by one or more nodes. FIG. 1 illustrates key components of an exemplary device that may at least partially provide and/or otherwise be included in an execution environment. The components illustrated in FIG. 4A and FIG. 4B may be included in or otherwise combined with the components of FIG. 1 to create a variety of arrangements of components according to the subject matter described herein.

FIG. 1 illustrates key components of an exemplary device that may at least partially provide and/or otherwise be included in an execution environment. The components illustrated in FIG. 4A and FIG. 4B may be included in or otherwise combined with the components of FIG. 1 to create a variety of arrangements of components according to the subject matter described herein.

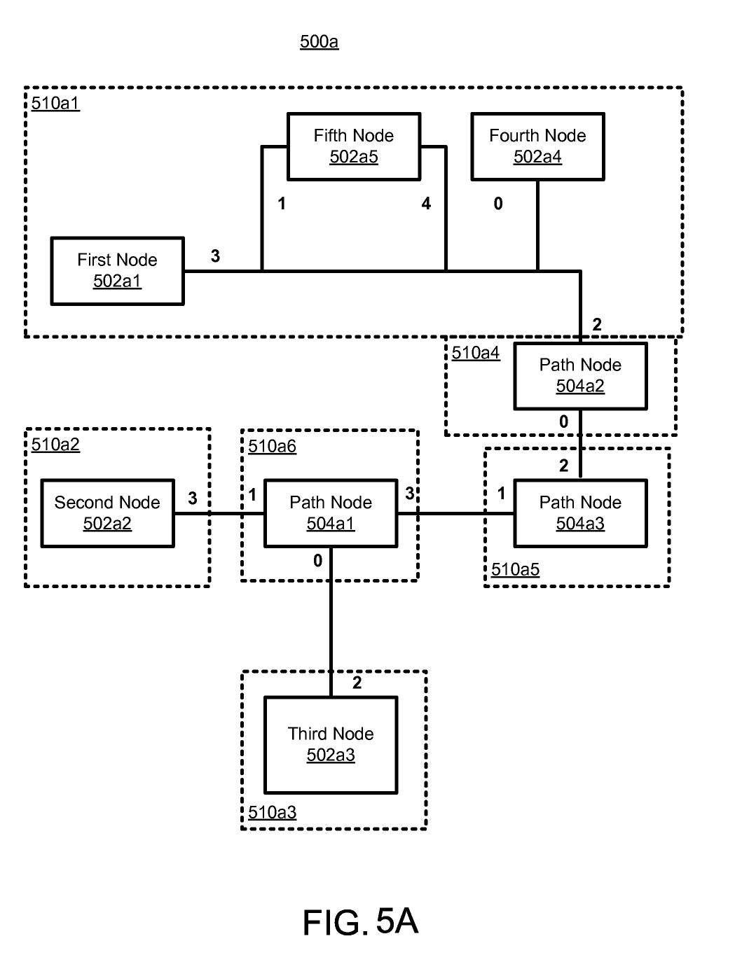

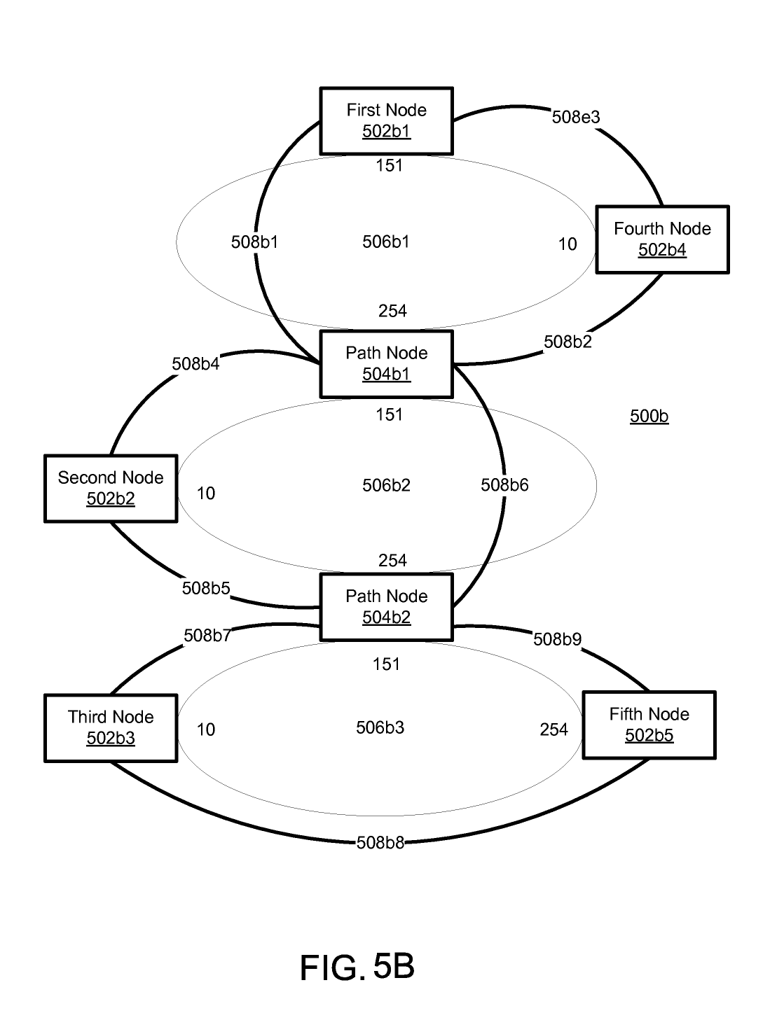

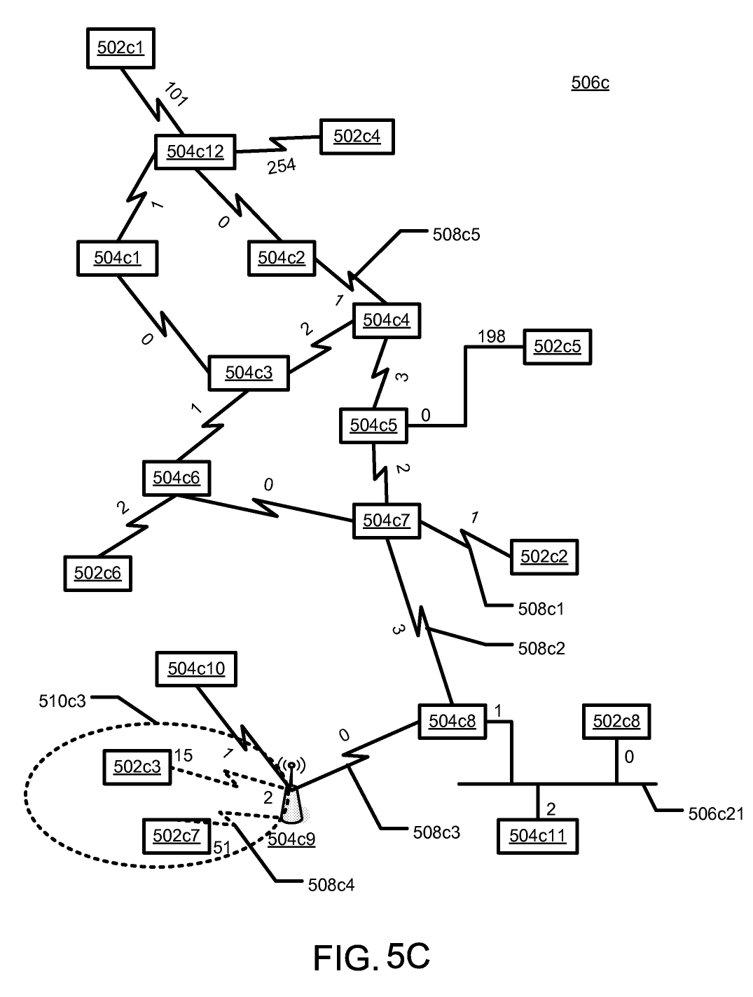

FIGS. 5A-C respectively illustrate networks 500 including nodes that in various aspects may include adaptations of any of the execution environments 401, illustrated in FIG. 4A and FIG. 4B. The various illustrated nodes are operatively coupled via network interface components to the respective networks 500 in FIGS. 5A-C. While any node may perform the method illustrated in FIG. 2, for ease of illustration, each of FIGS. 5A-C includes nodes 502 for describing adaptations of the arrangement in FIG. 3 performing different aspects of the method illustrated in FIG. 2. An adaptation of execution environment 401a, in FIG. 4A, may be described as being included in and/or operating in a node 502 in describing some aspects of the method illustrated in FIG. 2. In describing other aspects, a node 502 may be described as including and/or otherwise providing an adaptation of execution environment 401b in FIG. 4B. Other nodes, such as path nodes 504, in FIGS. 5A-C are described in terms of one or more roles they may play in interoperating with one or more nodes 502. Exemplary path nodes 504 include a router, a gateway, a switch, a virtual private network concentrator, a modem, a wireless access point, a bridge, a hub, a repeater, a firewall, a proxy server, an application that relays messages, and the like.

FIG. 4A illustrates an execution environment 401a hosting a program, illustrated by a communications application 403a that sends and/or receives data via a network stack 405a. FIG. 4B illustrates an execution environment 401b including a network directory system (NDS) service 403b, that sends and receives data by interoperating directly and/or indirectly with one or more components of a network stack 405b. The network stacks 405 in FIG. 4A and in FIG. 4B may be structured according to a layered architecture or model. FIG. 4A illustrates components that may be included in a network stack having a layered structure. A network stack 405b may be structured analogously or may be structured in another manner known to those skilled in the art. Some components illustrated in the network stack 405a correspond to components of the layered architecture specified by the Open System Interconnection (OSI) model, known to those skilled in the art. For example, network stacks 405 may comply with the specifications for protocols included in the TCP/IP protocol suite. The OSI model specifies a seven-layer stack. The TCP/IP protocol suite may be mapped to layers three and four of the seven layers. Those skilled in the art will understand that fewer or more layers may be included in various adaptation, analog, and instances of the execution environments 401 illustrated in FIG. 4A and in FIG. 4B and their various aspects described herein as well as other execution environments suitable to host an adaptation of the arrangement of components illustrated in FIG. 3.

An application, such as a communications application 403a and/or an NDS service 403b, operating in a node 502, may exchange data with another node 502 by interoperating with one or more components of a corresponding network stack 405. In FIG. 4A, a communications applications 403a may interoperate with a sockets component 407a to create a protocol endpoint, also referred to as a socket, to send data via one or more data units to and/or to receive data via a one or more data units from another node 502. The application may specify an attribute of a protocol to the sockets component 407a to open a specified type of protocol endpoint of a network protocol supporting the specified attribute.

FIG. 4A illustrates a sockets component 407a operatively coupled to a connectionless component 409a supporting an unreliable transport layer protocol where delivery of data is not guaranteed and a connection-oriented component 411a that supports a reliable transport layer protocol that guarantees data delivery or otherwise notifies the application of a delivery failure. The user datagram protocol (UDP) in the TCP/IP protocol suite is currently the most widely used connectionless transport layer protocol. The most widely used connection-oriented transport layer protocol currently in use is the transmission control protocol (the TCP) also included in the TCP/IP protocol suite.

Transport layer protocols supported by connectionless component 409a and by connection-oriented component 411a generate transport layer data units to include data received from an operatively coupled application to deliver the data via the data units according to a network layer protocol to a transport layer protocol endpoint, such as a socket, in another node 502. Analogously, data sent via an application in another node via a transport layer component may be received according to the network layer protocol by a compatible transport layer component, such as a connection-oriented component 411a and/or by a connectionless component 409a, to deliver via a socket to an application operating in the execution environment 401a in the receiving other node 502.

FIG. 4A illustrates a network layer component 413a that delivers data according to a network layer protocol from a source node to a destination node across a link, a LAN, a WAN, and/or an internet, such as the Internet and/or an intranet. Exemplary network layer protocols include various versions of the Internet Protocol (IP), the DECNet routing Protocol (DRP), the Internetwork Packet Exchange (IPX) protocol, the Internet Datagram Protocol (IDP), the VINES Internet Protocol, and the Datagram Delivery Protocol (DDP).

A network layer protocol delivers data across one or more communication links and/or networks between nodes in a network or internet. In FIG. 4A, a network layer component 413a may receive a transport layer data unit from a connection-oriented component 411a or a connectionless component 409a, or data from another component in execution environment 401a. The network layer component 413a may format and/or otherwise package the data in network layer data units. The data units may be sent, via a linker layer protocol, to a next node in a network path to a destination node.

One or more link layer protocols may be included in communicatively coupling a source node 502 and a destination node 502 via a network path that includes one or more path nodes 504 as illustrated in FIGS. 5A-C. In FIG. 4A, a network layer component 413a may provide a network layer data unit as data (i.e. a message) to a component supporting a link layer protocol compatible with exchanging data via a physical data transmission medium coupled to a NIC. A link layer component 415a, in FIG. 4A, illustrates a component in execution environment 401a supporting a link layer protocol. Exemplary link layer protocols include Ethernet, Token-ring, and asynchronous transfer mode (ATM), to name a few. Some or all of a link layer component 415a may be included in a NIC, as illustrated in FIG. 4A by a NIC 417a. A portion of a link layer component may be external to an operatively coupled NIC. The external portion may be realized, at least in part, as a device driver for the NIC. Exemplary physical data transmission media include Ethernet cables of various types, co-axial cable, and fiber optic cable, and various media suitable for carrying various types of wireless signals.

For ease of illustration, the description that follows focuses on IP networks and protocols in the TCP/IP suite due to their wide use and because they are well-known in the art. Those skilled in the art will understand that the scope of the subject matter described is not limited to IP networks.

With respect to FIG. 4A, a link layer component 415a may receive a network layer data unit for a network layer component 413a. The network layer data unit may be formatted as one or more IP protocol packets from the network layer component 413a supporting the Internet Protocol (IP). The link layer component 415a packages IP packets from network layer component 413a according to the particular link layer protocol supported. The link layer component 415a may include a network layer data unit in one or more link layer data units. Analogously, the link layer component 415a interprets data, received as signals transmitted by the physical medium operatively coupled to the NIC 417a, according to a particular link layer protocol supported to receive network layer data units in one or more link layer data units. The link layer component 415a may strip off link layer specific data and transfer the payload of the link layer data units to the network layer component 413a to process the included network layer data unit.

A network layer component 413a operating in a node 502 may communicate with one or more nodes 502 over a LAN, a link, and/or a network of networks such as an intranet or the Internet. A network layer component 413a in the node 502 may receive transport layer data units, for example, formatted as TCP packets from a connection-oriented layer component 411a and/or transport layer data units formatted as UDP packets from a connectionless component 409a illustrated in FIG. 4A. The network layer component 413a packages transport layer data units from the connection-oriented component 411a and/or the transport layer data units from the connectionless component 409a into network layer data units, such as IP packets, to transmit across a network 500 operatively coupled to the node. The network 500 may be and/or may include an internet.

Analogously, the network layer component 413a interprets data, received from a link layer component 415a in the node 502b, as IP protocol data and detects IP packets in the received data. The network layer component 413a may strip off IP layer specific data and transfer the payload of one or more IP packets to the connection-oriented layer component 411a and/or to the connectionless component 409a to process as transport layer data units according to a particular transport layer protocol.

As described above, FIG. 4A and FIG. 4B illustrate adaptations of network stacks 405 that send and receive data over a network, such as networks 500 illustrated in FIGS. 5A-C, via a network interface component, such as a NIC 417a. For example, a communications application 403a in FIG. 4A operating in a first node 502 may interoperate with an NDS service 403b and/or another application operating in a second node 502 via their respective network stacks: the network stack 405a and the network stack 405b.

In addition to the protocols described above, protocols corresponding to layers in the OSI model above the transport layer may be included in communicating via a network. The term “application protocol” as used herein refers to any protocol or combination of protocols that correspond to one or more layers in the OSI reference model above the transport layer. Programs and executables operating in execution environments 401 may communicate via one or more application protocols. Exemplary application protocols include a hypertext transfer protocol (HTTP), various remote procedure call (RPC) protocols, various instant messaging protocol, email protocol, and various presence protocols.

Data exchanged between nodes 502 in a network 500 may be exchanged via data units of one or more protocols. Each layer of a network stack may provide a layer specific protocol component. Some protocols, combine services from multiple layers of the OSI model into a single layer such as the Systems Network Architecture (SNA) protocol. Protocols define formats and vocabularies for constructing valid data units to exchange between and/or among protocol endpoints defined by the respective protocols. A network protocol also specifies and/or otherwise is compatible with one or more identifier spaces for identifying protocol endpoints to exchange data at respective layers of a network stack. The terms “identifier space” and “address space” are used interchangeably herein. For example, various versions of hypertext transfer protocol (HTTP) specify a format for HTTP uniform resource locators (URL). HTTP specifies a location in an HTTP header that identifies a URL as an identifier or address from the HTTP address space that identifies both a resource and recipient of an HTTP data unit. The transmission control protocol (TCP) specifies a format and vocabulary for a TCP header including a destination protocol endpoint field for including what the TCP refers to as a destination port number that, when combined with a destination protocol address from an IP packet, identifies a transport layer protocol endpoint of a receiver of data included in a TCP data unit. A sending endpoint is similarly identified by a source port number included in a source protocol endpoint field of a TCP data unit and a source protocol address from an IP data unit.

Other exemplary address spaces that identify protocol endpoints in various protocols include an email address space identifying a protocol endpoint transported by various email protocols such as a simple mail transfer protocol (SMTP) and a post office protocol (POP), a telephone number address space for various telephony protocols, instant message address spaces for various instant message protocols, and media access control (MAC) addresses for various link layer protocols, to name just a few examples.

In delivering data across a network between protocol endpoints, addresses from address spaces of the various protocols at the various layers are translated and/or otherwise mapped between the various layers. For example, a unicast IP address in an IP packet is mapped to link layer addresses for the various links the IP packet is transported across in a network path via a path node 504 between a source node 502 sending the IP packet and a destination node 502 receiving the IP packet. Addresses at the various layers are assigned from a suitable address space.

Since addresses from address spaces at various layers of a network stack are often not suited for remembering and/or identifying by users, an address space of symbolic identifiers or names may be used to provide aliases for addresses in an address space identifying protocol endpoints corresponding to a protocol supported by a layer of a network stack. The domain name space is a well-known identifier space of names for identifying nodes and/or network interfaces as protocol endpoints of the IP protocol in the Internet, private internets, and intranets. The domain name system (DNS) is a collection of domain name system services maintaining databases that associate names from the domain name space with protocol addresses, in particular with IP addresses. The domain name space defines a global name space shared across the Internet.

FIG. 4B illustrates an execution environment 401b hosting a network directory system (NDS) service 403b, such as a DNS service. An adaptation of the arrangement of components in FIG. 3 is illustrated operating in the NDS service 403b. The NDS service 403b receives a request from an NDS client component 419a in FIG. 4A to resolve a symbolic identifier to a protocol address of a protocol endpoint. A communications application 403a or other component in an execution environment 401a may communicate with an NDS service 403b via an application specific NDS protocol supported by a NDS client component 419ba illustrated in FIG. 4A and a server NDS protocol component 421b in FIG. 4B. A server NDS protocol component 421b may communicate with other NDS services in other nodes included in an NDS system. Exemplary NDS protocols include the DNS protocol, the lightweight directory access protocol (LDAP), and the X.500 protocol.

FIG. 4A illustrates an adaptation of the arrangement of component in FIG. 3 operating partially in a network layer component 413a. Other adaptations of the arrangement in FIG. 3 may operate in one or more components external to network layer, such as an NDS client component 419a.

FIG. 5B, illustrates a network path, as defined above, for transmitting data between a first node 502b1 and a second node 502b2 in a network 500b. The network path includes a sequence of nodes including the first node 502b1, a first path node 504b1, and the second node 502b2. In FIG. 5C, a first network path communicatively coupling a second node 502c2 and an eighth path node 504c8 includes a first sequence of nodes including the second node 502c2, a seventh path node 504c7, and the eighth path node 504c8. The first network path is included in a second network path communicatively coupling the second node 502c2 and a seventh node 502c7 that includes a second sequence of nodes including the nodes in the first sequence, a ninth path node 504c9, and the seventh node 502c7. A network path may be a physical network path or a logical network path based on a particular network protocol defining the protocol endpoints.

FIG. 5B, illustrates a number of network paths and hop paths communicatively coupling a first node 502b1 and a fifth node 502b5 in a network 500b. One hop path illustrated includes a sequence of hops including a first hop 508b1, a sixth hop 508b6, and a ninth hop 508b9. In FIG. 5C, the first network path described above communicatively coupling the second node 502c2 and the eighth path node 504c8 includes a first sequence of hops including a first hop 508c1 and a second hop 508c2. The first network path is included in the second network path described above that includes a second sequence of hops including the first sequence of hops, a third hop 508c3, and a fourth hop 508c4.

In FIG. 5B, the network path described above communicatively coupling the first node 502b1 and the fifth node 502b5 includes a sequence of network interfaces including a network interface in the first path node 504b1 in the first hop 508b1, a network interface in the second path node 504b2 in the sixth hop 508b6, and a network interface in the fifth node 502b5 in the ninth hop 508b9. The network paths, in FIG. 5C and described above, may analogously be described as a sequence of network interfaces.

With reference to FIG. 2, block 202 illustrates that the method includes detecting first path information that identifies a first sequence of nodes in a first network path for transmitting data between a first node and a second node in a network. Accordingly, a system for identifying a protocol address based on path information includes means for detecting first path information that identifies a first sequence of nodes in a first network path for transmitting data between a first node and a second node in a network. For example, in the arrangement in FIG. 3, detecting first path information that identifies a first sequence of nodes in a first network path for transmitting data between a first node and a second node in a network is performed via operation of the path detector component 302. FIGS. 4A-B illustrate path detector components 402 as adaptations and/or analogs of the path detector component 302 in FIG. 3. One or more path detector components 402 operate in an execution environment 401. A system for identifying a protocol address based on path information includes one or more processors and logic encoded in one or more tangible media for execution by the one or more processors that when executed is operable for and/or is otherwise included in detecting first path information that identifies a first sequence of nodes in a first network path for transmitting data between a first node and a second node in a network.

In FIG. 4A, a path detector component 402a is illustrated as a component of the network layer component 413a. In FIG. 4B, another adaptation of a path detector component 402b is illustrated as a component of the NDS service component 403b. In an aspect, a node 502 may include a path detector component 402a illustrated in FIG. 4A. In another aspect, a node 502 may include a path detector component 402b illustrated in FIG. 4B. In still another aspect, a node 502 may include adaptations of both types of path detector components 402. Path nodes 504 may also include adaptations of path detector components.

Returning to FIG. 2, block 204 illustrates that the method further includes detecting second path information that identifies a second sequence of nodes in a second network path for transmitting data between the second node and a third node in the network. Accordingly, a system for identifying a protocol address based on path information includes means for detecting second path information that identifies a second sequence of nodes in a second network path for transmitting data between the second node and a third node in the network. For example, as illustrated in FIG. 3, detecting second path information that identifies a second sequence of nodes in a second network path for transmitting data between the second node and a third node in the network is performed via operation of the address space director component 304. FIGS. 4A-B illustrate address space director components 404 as adaptations and/or analogs of the address space director component 304 in FIG. 3. One or more address space director components 404 operate in an execution environment 401. A system for identifying a protocol address based on path information includes one or more processors and logic encoded in one or more tangible media for execution by the one or more processors that when executed is operable for and/or is otherwise included in detecting second path information that identifies a second sequence of nodes in a second network path for transmitting data between the second node and a third node in the network.

In FIG. 4A, an address space director component 404a is illustrated as a component of the network layer component 413a. In FIG. 4B, an address space director component 404b is illustrated as component of the NDS service component 403b. For example, a node 502 may include an address space director component 404a. A node 502 in other aspects may include an address space director component 404b. In still other aspects, a node 502 may include adaptations of both types of address space director components 404. Path nodes 504 may also include adaptations of address space director components.

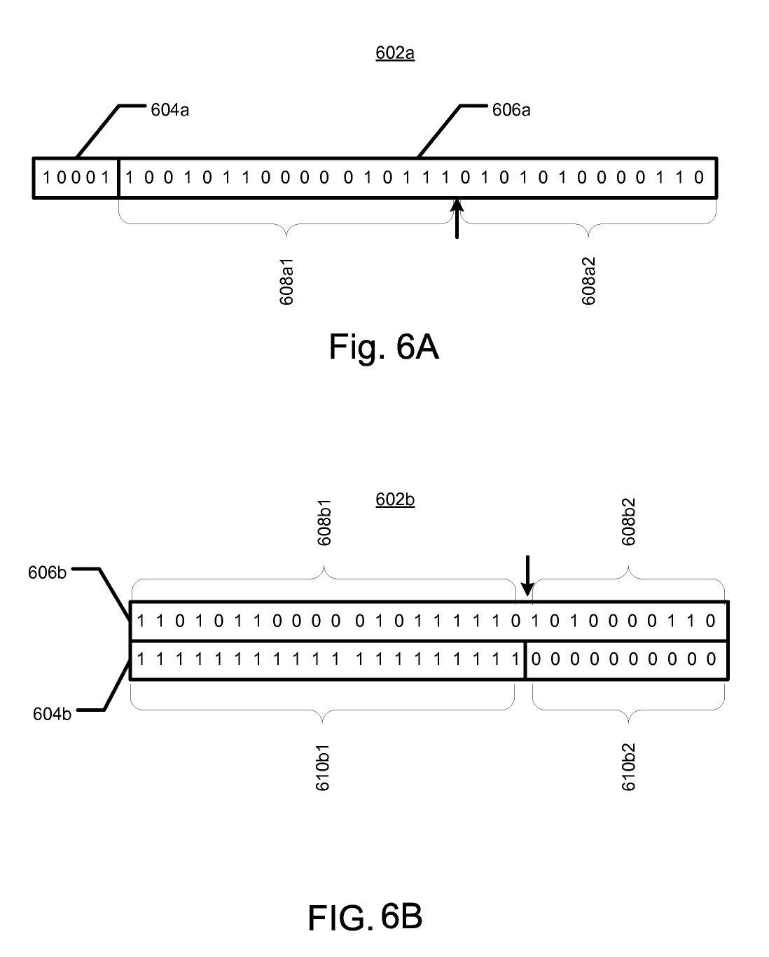

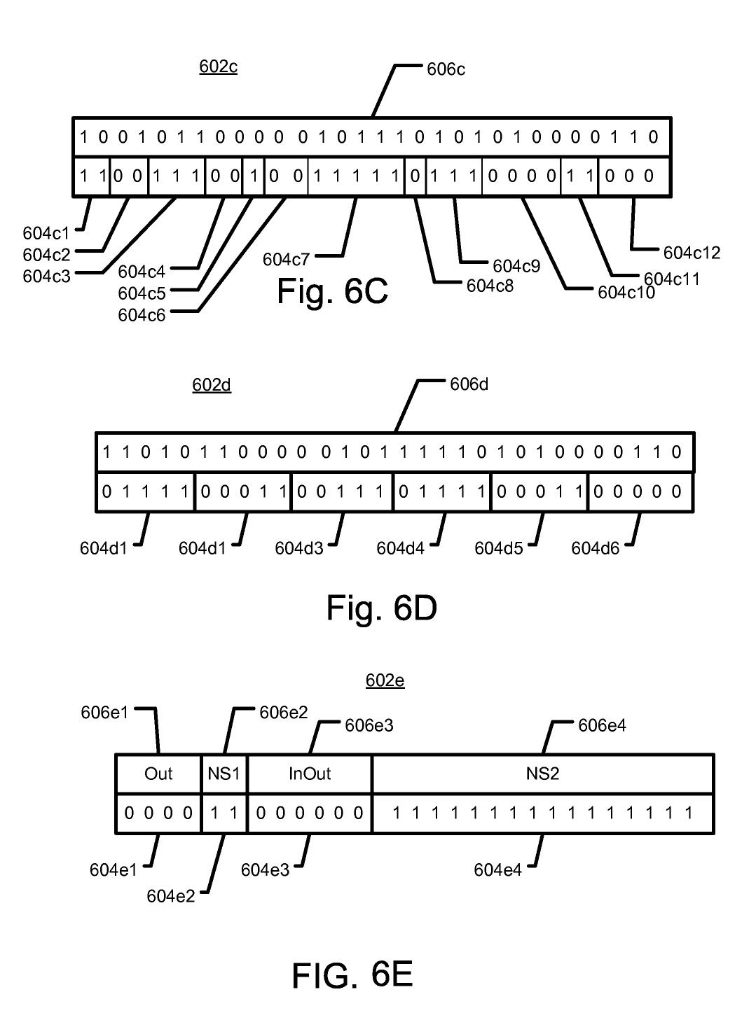

Path information may be detected in various ways in various aspects. With respect to FIG. 5A and FIG. 4A, an adaptation, analog, or instance of execution environment 401a may be included and/or otherwise may be provided by a first node 502a1 in a network 500a. A path detector component 402a in the first node 502a1 may receive and/or otherwise detect path information from a communications application 403a and/or one or more of a sockets component 407a, a connection-oriented component 411a, a connectionless component 409a, and an NDS client component 419a. The path information may identify a network path that includes the first node 502a1 as a path end node. Alternatively or additionally, the path information may include a protocol address that identifies the network path. The protocol address may be formatted as required and/or otherwise allowed by the network protocol supported by the network layer component 413a. Schemas for representing protocol addresses in data units of a network protocol are illustrated in FIGS. 6A-E described below. Alternatively or additionally, the protocol address may be represented in another form, such as text string.

With respect to FIG. 5A, the first node 502a1 may identify a protocol endpoint in a second node 502a2 by a protocol address that includes path information. The protocol address identifies the second node 502a2, identifies the protocol endpoint, and identifies a network interface of the second node 502a. The communications application 403a in the first node 502a1 may provide data to send to the second node 502a2 by providing path information included in and/or otherwise for identifying the protocol address. The path information may be detected by the path detector component 402a. The path detector component 402a may include instructions for interoperating with a packet generator component 433a to generate and/or store a representation of the protocol address including path information in a data unit specified according to the network protocol, such as the Internet Protocol, supported by the network layer component 403a.

In FIG. 5A, in an aspect, 2.2.3.3 identifies a sequence of network interfaces for receiving one or more data units including data sent from the first node 502a1 to the second node 502a2. The sequence of network interfaces is included in nodes in a network path that identifies the second node 502a2 with respect to the first node 502a1 as well as to other nodes in a first region 510a1 of the network 500a. The sequence may be represented in and/or otherwise by the protocol address as a destination protocol address in a data unit. Exemplary address representations are described below with respect to FIGS. 6A-E.

A packet generator component 433a in the first node 502a1 may include one or more instructions that when performed by the first node 502a1 identify a source protocol address based on path information represented in the data unit to identify the first node 502a1 as the source node of the data in the data unit. The packet generator component 433a may interoperate with an address space director component 404a to receive the source address information that includes and/or otherwise identifies path information to include a representation of the source protocol address in the data unit.

In an aspect, the address space director component 404a in the first node 502a1 may identify a source protocol address that identifies the first node 502a1 to the second node. The path information may include a numeric sequence 1.1.0.3, which identifies a sequence of receiving network interfaces in a network path from the second node 502a2 to the first node 502a1. The source protocol address may be pre-specified to the first node 502a1 via a user and/or may be pre-specified based on a previous communication with the second node 502a2. The source protocol address may be retrieved via a request to a network directory service, as described in more detail below, in another aspect.

In still another aspect, the package generator component 433a may receive source address information that identifies path information in a protocol address that identifies the first node 502a1 to the second node 502a2. In one aspect, illustrated in FIG. 5A, the number ‘3’ may be a local scoped address that identifies a network interface of the first node 502a1 in the scope of the first region 510a1. As the data is transmitted via the network path identified by the destination protocol address to the second node 502a2, the source path information included in one or more data units, that are included in transmitting the data, may be augmented and/or otherwise updated to provide source path information from which the second node 502a2 may detect and/or may otherwise determine a protocol address that identifies the first node 502a1 to the second node 502a2 via path information in a source address representation in a data unit of the network protocol.

As described above and further below, path information for a network protocol may be detected in a data unit of the network protocol. The path information may be detected by a node transmitting the data unit and/or may be detected by a node receiving the data unit.

In another aspect, a message may be sent to a network directory service to register a name or symbolic identifier for a node and/or a network interface of a node. The network directory service may associate the symbolic identifier with address information, which as described herein may be path information. Path information may be detected in the registration message and/or in one or more data units of a network protocol for which an association is to be created and/or otherwise maintained by a network directory service. Further, a response to the registration message may be exchanged between the registering node and the network directory service node. The response message and/or one or more data units included in transmitting the response may include and/or otherwise identify path information that may be detected by either node. Nodes in a network path transmitting the response and/or the registration request may detect path information in one or more data units received and/or sent in relaying some or all of one or both messages.

With respect to FIG. 5A and FIG. 4B, the second node 502a2 may include and/or may otherwise provide an adaptation, analog, and/or instance of execution environment 401b. With respect to FIG. 5A and FIG. 4A, a third node 502a3 may be and/or may include an adaptation, analog, and/or instance of execution environment 401a. An NDS client component 419a in the third node 502a3 may send a registration message via an NDS protocol component 421a in the third node 502a3. The registration message may include address information for receiving by a client communication component 429b, illustrated in FIG. 4B, in the second node 502a2. The registration message, in one aspect may include a symbolic identifier, such as a DNS name, and may include path information and/or one or more data units may include the path information identifying a network path included in transmitting the registration message from the third node 502a3 to the second node 502a2. The data may be received by the client communications component 429b that operates to create and/or update a record associating the symbolic identifier with some or all of the path information. The client communication component 429b may provide the data, directly and/or indirectly, to the path detector component 402b in interoperating, directly or indirectly, with an address space director component 404b to create and/or update the record.

Still further, a node may send a symbolic identifier to a network directory service in a resolve message in order to resolve the symbolic identifier to a protocol address of a node and/or a network interface identified by the symbolic identifier. Path information may be detected in the resolve message and/or in one or more data units of a protocol that the symbolic identifier is associated with in an association maintained by a network directory service. Further, a response to the resolve message may be exchanged between the requesting node and the network directory service node. The response message and/or one or more data units included in transmitting the response may include and/or otherwise identify path information that may be detected by either node. Nodes in a network path transmitting the response and/or the registration request may detect path information in one or more data units that they receive and/or send in relaying some or all of one or both messages.

The second node 502a2 may receive path information in and/or otherwise based on a resolve message including a request to resolve the symbolic identifier of the third node 502a3 to a protocol address that identifies, for a network protocol, the third node 502a3 with respect to the first node 502a1. The resolve message may be received by the communications client component 429b and/or by a system communications component 431b. Path information identifying a network path between the first node 502a1 and the second node 502a2 may be included in the resolve message and/or may be detected in one or data units of the network protocol received by the second node 502a2 in receiving the resolve message.

Returning to FIG. 4A and FIG. 5A, path information may be detected by an address space director component 404a operating in a network layer component 413a in an address representation in a data unit received via the network 500a. An adaptation, analog, and/or instance of execution environment 401a may be included in and/or otherwise may be provided by the third node 502a3 in a third region 510a3 in the network 500a. A path detector component 402a in the third node 502a3 may receive and/or otherwise detect path information in a data unit received from another node, such as the second node 502a2 via a NIC 417a and a link layer component 415a operating in the third node 502a3, as described above. The data unit may be received from the link layer component 415a by a packet detector component 435a.

The packet detector component 435a may detect an address representation in the data unit according to a schema defined by a network layer protocol supported by the network layer component 413a. The path information represented may be provided to a path detector component 402a. An address space director component 404a operating in the third node 502a3 may receive and/or otherwise detect the path information via the path detector component 402a. When the protocol address, identified in path information is detected by the address space director 404a, is not in an address space that is usable for sending data to another node, the address space director component 404a may determine a protocol address in a suitable address space as described in more detail below. In one aspect, the address space director component 404a may receive path information that identifies the third node 502a3 with respect to the second node 502a2. The address space director component 404a may determine a protocol address that identifies the second node 502a2 with respect to the third node 502a3 based on the received path information. The data in the data unit may be provided by the network layer component 413a to a protocol endpoint identified by a higher layer protocol as described above.

FIGS. 6A-E illustrate a number of exemplary address representations 602 illustrating various aspects of address formats and vocabularies for representing path-based addresses. Various portions of the respective address representations 602 are illustrated as contiguous, but need not be so in various embodiments according to the subject matter described herein. Each of the types of address representations 602 shown in FIGS. 6A-E may be included in a destination protocol address portion and/or a source protocol address portion of an IPv4 data unit header and/or of an IPv6 data unit header. Path information may be detected by processing a bit pattern or identifier defined to identify a protocol address as a path-based address. The bit pattern or identifier may be stored in a type bits portion of an IP packet and/or in some other specified location.

FIG. 6A illustrates an address representation 602a that may be included in a data unit or packet of an Internet Protocol (IP). An address representation 602a may identify one or more path-based addresses for one or more respective nodes in a network path for transmitting data from one path end node to another. In an aspect, an address representation 602a may be processed as including at least three portions. An address separator field 604a is illustrated including a binary number. In FIG. 6A, the binary number illustrated equals seventeen in base ten. The number in the address separator field 604a identifies a boundary in an address information field 606a separating a first address field 608a1 and a second address field 608a2. The first address field 608a1 may identify first path information. The first path information may identify a first network path from a first node to a second node. The first path information may be included in a first-second path-based address that identifies the second node to the first node. The second address field 608a2 may identify second path information. The second path information may identify a second network path from the second node to a third node. The second path information may be included in a second-third path-based address that identifies the third node to the second node. The address information field 606a identifies third path information that includes the first path information and the second path information. The third path information may identify a third network path from the first node to the third node.

With respect to FIG. 5A, an address representation 602a may be included in a data unit including data from the first node 502a1 to transmit to the second node 502a2. As described above, a network path may be identified by a sequence of receiving network interfaces. Path information may identify the sequence 2.2.3.3, which identifies receiving network interfaces in a network path illustrated in FIG. 5A from the first node 502a1 to the second node 502a2. The path information may be represented in an address information field 606a to identify a first-second protocol address that, for the first node 502a1, identifies the second node 502a2.

At the first node 502a1, a path detector component 402a may set and/or otherwise detect a value in the address separator field 604a that indicates a first address field 608a1 has a zero size. The entire address information field 606a thus constitutes a second address field 608a2 at the first node 502a1 and identifies first path information in a first-second protocol address that may be set and/or otherwise detected by the path detector component 402a.

At a third path node 504a3, an address separator field 604a in a data unit including the data from the first node 502a1 may be set to and/or otherwise detected, by a path detector component 402a in the third path node 504a3, as a value that identifies, 2.2, in a first address field 608a1. The information in the first address field 608a1 identifies path information that identifies a network path from the first node 502a1 to the third path node 504a3. The value in the address separator field also identifies a second address field 608a2 that identifies 3.3 as path information that identifies a network path from the third path node 504a3 to the second node 502a2.

At the second node 502a2 a data unit including the data from the first node 502a1 may include a value, set and/or detected by a path detector component in the second node 502a2, in an address separator field 604a that indicates that the address information field 606a includes only a first address field 608a1 identifying 2.2.3.3, the first path information.

As the data from the first node 502a1 is transmitted from node to node in the network path the value represented in an address separator field 604a in an address information field 606a in a data unit including the data or a portion thereof may be adjusted by path detector components 402a in the nodes in the network path to identify a protocol address in a suitable address space for the respective nodes.

The above describes path information in an address representation 602a processed as destination address information in a data unit of a network protocol, such as an IP protocol. An address representation 602a, may include path information that may be processed as source address information with respect to a node receiving a data unit of the network protocol, described in the previous paragraph, as included in sending data from the first node 502a1 to the second node 502a2. An address information field 606a including source address information at the third path node 504a3 may include a first address field 608a1 identifying the sequence 0.3 that identifies a path-base protocol address that identifies the first node 502a1 as the source node for the data in the data unit. The address information field 606a including the source address information at the third path node 504a3 may include a second address field 608a2 identifying the sequence 1.1 that identifies a path-based protocol address that identifies the third path node 504a3 to the second node 502a2.

A data unit may include separate address representations for path information processed as destination address information including path information and source address information including path information Alternatively, a data unit such as an IP packet may include an address representation that identifies path information processed as source address information in context of a receiving node and processed as destination address information in the context of a node sending the data to the receiving node. Rather than requiring separate source and destination representations as current IP packet headers require, a single address representation may identify path information that may be processed as source address information and may be processed as destination address information.

FIG. 6B illustrates another type of address representation 602b that may be included in a data unit to provide path information according to a particular network protocol, such as IP or IPX. Instead of or in addition to including an address separator field 604a, as in FIG. 6A, that distinguishes a first address field 608a1 from a second address field 608a2 based on a bit count, a bit-mask may be specified as one or more address separator fields 604b to identify a first address field 608b1 and a second address field 608b2b in an address information field 606b. Path information represented as illustrated in FIG. 6B may be processed in an analogous manner to that described for the path information represented in FIG. 6A based on the bit mask address separator field(s) 604b rather than and/or in addition to a size address separator field 604a illustrated in FIG. 6A. In FIG. 6B a change in bit values in bit mask address separator field 604b from 1 shown in a first address separate portion 610b1 to 0 in second address portion 610b2 marks the boundary between first address field 608b1 and second address field 608b2.

FIG. 6C illustrates an address representation 602c identifying path information. An address information field 606c may be interpreted as a network path identifier based on one or more address separator field(s) 604c. Address separator fields 604c are specified according to a network protocol to distinguish one path identifier from another path identifier in an address information field 606c. FIG. 6C illustrates an address separator field 604 that distinguishes and/or identifies hop identifiers. A network path may include a single hop. The address separator fields 604c may distinguish separate hop identifiers based on changes in values of bits in consecutive address separator fields 604c. In FIG. 6C, a first address separator field 604c1 includes one or more 1-valued bits that correspond to bit positions in the address information field 606c to identify a first address field referred to in FIG. 6C as a first hop information field. Network paths that include more than one hop may be distinguished similarly as shown in FIG. 6B. Combinations of hop identifiers and path identifiers may be distinguished by address separator fields 604 in some aspects. As illustrated, a second hop information field 604c2 includes one or more 0-valued bits to identify a second hop information field in the address information field 606c. Additional alternating sequences of 1-valued bits and 0-valued bits illustrated by address separator fields 604c3-12c correspond to and identify other hop information fields identifying hops in a network path communicatively coupling a pair of path end nodes.

In FIG. 5C, a hop may be identified by an interface identifier of a network interface in a pair of nodes included in the hop. For example, the number 1 may serve as a hop identifier specific to a second path node 504c2 for identifying a fifth hop 508c5 including the second path 504c2 and a fourth path node 504c4. The number 1 also identifies a network path for exchanging data between the two nodes. The number 1 may also be a protocol address that identifies the fourth path node 504c4 with respect to the second path node 504c2 and may identify the second path node 504c2 with respect to the fourth path node 504c4. As a hop identifier, the number 1 may also identify a hop for the fourth path node 504c4 to exchange data with the second path node 504c2. Similarly, the number 1 may also identify a hop for the second path node 504c2 to exchange data with the fourth path node 504c4.

A first node 502c1 may identify a second node 502c2 based on first-second path information that identifies a network path from the first node 502c1 to the second node 502c2. The first-second protocol address may include and/or otherwise may be based on a sequence of hop identifiers 101.0.1.3.2.1. Note that other network paths are illustrated for transmitting data from the first node 502c1 to the second node 502c2 and may also be and/or otherwise may identify protocol addresses that identify the second node 502c2 to the first node 502c1.

The second node 502c2 may identify a third node 502c3 based on second-third path information included in a second-third protocol address of a network protocol that identifies the third node 502c3 to the second node 502c2. The protocol address may be based on a sequence of hop identifiers 1.3.0.15, which identifies the third node 502c3 with respect to the second node 502c2. The third node 502c3 is in a third region 510c3. Within the third network region 510c3, the third node 502c3 may be identified by a local-scoped address 15.

The hop identifiers 101.0.1.3.2.1 may be represented in an address representation 602c in a data unit to send data from the first node 502c1 to the second node 502c2. The hop identifiers 1.3.0.15 may be represented in an address representation 602c in a data unit to send data from the second node 502c2 to the third node 502c3. The identifiers may be given a bit or binary representation and the hop identifiers may be distinguished or separated via an address separator field 604c as described above with respect to FIG. 6C. An address separator field analogous to that shown in FIG. 6A may also be included and processed as described above. Assignment of hop identifiers is described in

Application Ser. No. 13/727,649 (Docket No DRV0026) filed on 2012 Dec. 27, entitled “Methods, Systems, and Computer Program Products for Assigning an Interface Identifier to a Network Interface”; application Ser. No. 13/727,655 (Docket No DRV0030) filed on 2012 Dec. 27, entitled “Methods, Systems, and Computer Program Products for Determining a Shared identifier for a Hop in a Network”, and application Ser. No. 13/727,657 (Docket No DRV0031) filed on 2012 Dec. 27, entitled “Methods, Systems, and Computer Program Products for Determining a Hop Identifier for a Network Protocol”.

Note that the path information that identifies protocol addresses for the second node 502c2 and for the third node 502c3 in the preceding description may include information for identifying a return network path or a portion thereof. For example, the second-third protocol address, 1.3.0.15 identifies, 3.1, which may be part of a path-based protocol address that identifies the second node 502c2 with respect to the third region 510c3. The path-based protocol address, 1.2.3.1.0.101, identifies a network path from the second node to the first node 502c1. Separate source address information may be included in a data unit sent to the second node 502c2 that includes data sent from the first node 502c1. The source address information may identify 1.2.3.1.0.101 as information that is included in a path-based address that identifies the first node 502c2 with respect to the second node.

As described in the previous paragraph, a hop may be assigned an identifier that is shared by the pair of nodes in the hop. Thus, a sequence of hop identifiers may serve as a first path-based address when the sequence is processed in one order. The sequence may serve as another path-based address when the sequence is processed according to another order. Any of the address types illustrated in FIGS. 6A-E, along with various variants and analogs, are suitable for including reversible path information.

FIG. 6D includes an address representation 602d illustrating aspects of a schema for representing path information based on identifiers of network interfaces or other suitable pairs of numbers for identifying protocol endpoints of a hop and/or a network path. An address information field 606d may include path information identifying a network path communicatively coupling a pair of path end nodes in the network path. FIG. 6D illustrates that an address representation 602d may include one or more address separator fields 604d that correspond to and/or otherwise identify one or more respective portions of the address information field 606d that are based on a pair of identifiers of protocol endpoints.

An exemplary address separator field 604c includes series of 1-valued bits and 0-valued bits. A change from a 1 value to a 0 value and vice versa may indicate a boundary separating protocol endpoint identifiers or interface identifiers. An address separator field 604d1 includes one 0-valued bit followed by four 1-valued bits. The 0-valued bit may be defined to indicate that a first network interface in a first hop identifier is one bit long with a corresponding position in the address information field 606d.

FIG. 6D identifies the first interface identifier as the number 1 in base ten. The four 1-valued bits in the first address separator field 604d1 may be similarly defined to identify the location of a second interface identifier in the first hop identifier. The second interface identifier, as illustrated in FIG. 6D, has the value 10 in base ten. The first hop identifier includes the numbers 1 and 10. A second hop identifier is located by the end of the series of four 1-valued bits in the first address separator field 604d1 to a series of three 0-valued bits that identify a boundary of a second address separator field 604d2 for second hop information identifying a second hop identifier, and the three 0-valued bits also identify the location of a first interface identifier in second hop information in the address information field 606d. Two subsequent 1-valued bits identify the location in the address information field 606d of a second interface identifier in the second hop information. The second hop identifier includes the numbers 6 and 0 in base ten. The remaining address separator fields 604d may be processed similarly. The protocol address illustrated FIG. 6D may be represented textually as 1-10.6-0.0-5.1-14.5-0.6.

Note that the address separator field 604d6 does not identify a pair of identifiers and is similar to address separator fields 604c in FIG. 6C. Alternatively, an address separator field 604d may correspond to a portion of an address information field 606d that identifies a scoped address. This is illustrated to demonstrate that protocol addresses may be uniform or non-uniform in their format and content.

In FIG. 5B, the first node 502b1 and the second node 502b2 may identify the other by a path-based address. For example, a sequence of pairs of interface identifiers 151-254.151-10 is path information that may be included in a path-based address that identifies the second node 502b2 with respect to the first node 502b1. The first node 502b1 may send a data unit including an address representation 602d of the type illustrated in FIG. 6D. Note that reversing the interface identifiers yields the identifier 10-151.254-151 that is path information that may be included in a path-based address that identifies the first node 502b1 with respect to the second node 502b2.

The second node 502b2 and a third node 502b3 may identify the other by a path-based address. A sequence of pairs of interface identifiers 10-254.151-10 is illustrated in FIG. 5B as path information that may be included in a protocol address that identifies the third node 502b3 to the second node 502b2. Reversing the interface identifiers yields the identifier 10-151.254-151 that is illustrated as path information that may be included in a path-based address that identifies the second node 502b2 with respect to the third node 502b3. A sequence of hop identifiers, based on interface identifiers, may serve as a path-based address when the interface identifiers are processed in one order. The sequence of hop identifiers may serve as another path-based address when the interface identifiers are processed according to another order.

FIG. 6E illustrates an address representation 602e that further demonstrates that a protocol address may be based on path information. An address representation 602e may include portions that include path information. Path information may include one or more scoped addresses. An address separator field 604e may be defined to distinguish address fields in a manner similar to the method described for distinguishing hop identifiers in FIG. 6C. A first address information field 606e1 corresponding to the first address separator field 604e1 includes a single interface identifier for an outbound network interface for a first node as described above with respect to FIG. 6A and FIG. 5C. A second address information field 606e2 corresponding to a second address separator field 604e2 may include a scoped address having an inside scope, an outside scope, or both.

See application Ser. No. 11/962,285, by the present inventor, filed on 2007 Dec. 21 and incorporated by reference in its entirety, entitled “Methods and Systems for Sending Information to a Zone Included in an Internet Network” for a description of addresses having outside scope and/or inside scope and processing of such addresses. A third address information field 606e3 corresponding to a third address separator field 604e3 may include a pair of identifiers as described with respect to FIG. 6D. A fourth address information field 606e4 corresponding to a fourth address separator field 604e4 may include a protocol address analogous to one of the types of addresses described with respect to the second address information field 606e2 such as a local-scoped address.

In FIG. 5B, each of the first node 502b1 and the second node 502b2 may be operatively coupled to the network 500b via a respective network interface. Each of the two nodes may identify the other by a protocol address that is a path-based address. For example, a sequence of scoped addresses 254.10 may be a path-based address that identifies the second node 502b2 with respect to the first node 502b1 in a first-second protocol address. A data unit including an address representation 602e in FIG. 6E may identify a path-based address based on a sequence of scoped addresses. Similarly, a sequence of scoped addresses 254.10 may be a path-based address that identifies a third node 502b3 to the second node 502b2.

Returning to FIG. 2, block 206 illustrates that the method yet further includes determining, based on the first path information and the second path information, a first-third protocol address that identifies, according to a network protocol, the third node to the first node for transmitting data from the first node to the third node. Accordingly, a system for identifying a protocol address based on path information includes means for determining, based on the first path information and the second path information, a first-third protocol address that identifies, according to a network protocol, the third node to the first node for transmitting data from the first node to the third node. For example, as illustrated in FIG. 3, determining, based on the first path information and the second path information, a first-third protocol address that identifies, according to a network protocol, the third node to the first node for transmitting data from the first node to the third node is performed via operation of path composer component 306. FIGS. 4A-B illustrate path composer components 406 as adaptations and/or analogs of path composer component 306 in FIG. 3. One or more path composer components 406 operate in an execution environment 401. A system for identifying a protocol address based on path information includes one or more processors and logic encoded in one or more tangible media for execution by the one or more processors that when executed is operable for and/or is otherwise included in determining, based on the first path information and the second path information, a first-third protocol address that identifies, according to a network protocol, the third node to the first node for transmitting data from the first node to the third node.

In FIG. 4A, a path composer component 406a is illustrated as a component of a network layer component 413a. In FIG. 4B, a path composer component 406b is illustrated as a component of an NDS service component 403b. For example, a node may include a path composer component 406a. In other aspects, a node 502 may include a path composer component 406b. In still other aspects, a node 502 may include adaptations of both types of path composer components 406. Path nodes 504 may also include adaptations of path composer components.

Returning to FIG. 5A and FIG. 4B, the second node 502a2 may receive a resolve message, as described above from the first node 502a1 that includes a symbolic identifier of the third node 502a3. A request to resolve the symbolic identifier may be received by the client communication component 429b as described above. The request may be to resolve the symbolic identifier to a protocol address of a network protocol that identifies the third node 502a3 in a data unit of the network protocol sent by the first node 502a1 to transmit data in the data unit to the third node 502a3. The client communication component 429b may interoperate with a path composer 406b to determine the protocol address. The path composer, in an aspect, may determine whether the symbolic identifier is in a name domain managed by the NDS service 403b. If the symbolic identifier is in a domain managed by the NDS service 403b, the path composer 406b in the second node 502a2 may request an address space director component 404b to lookup address information to determine the protocol address.

The address space director component 404b may locate path information associated with the symbolic identifier stored in a record or via some other association in an ID-address data store 425b. If the symbolic identifier is located in the ID-address data store 425b, the address space director component 404b receives and/or otherwise detects path information associated with the symbolic identifier. If the path composer 406b determines that the symbolic identifier is not in a domain of the NDS service 403a in the second node 502a2, the path composer may request that the address space director component 404b lookup and/or otherwise detect the path information to determine the protocol address via a lookup in a DB cache 427b that stores information received from other NDS services operating in other nodes that manage other domains in the name space of symbolic identifiers.

If the symbolic identifier is not located in the DB cache 427b, the path composer 406b may instruct the system communication component 431b in the second node 502a2 to send the symbolic identifier to a node that includes an NDS service that manages the domain that includes the symbolic identifier. The other node may resolve the symbolic identifier, partially resolve the symbolic identifier, and/or may send path information back to the second node 502a2 for the path composer 406a to resolve the symbolic identifier.

As described various types of protocol addresses may conform to various schemas defining rules for formatting valid protocol addresses and/or defining vocabularies specifying valid content of a protocol address. Given first address information identifying a first network path and second address information identifying a second network path as described above with respect to the method illustrated in FIG. 2, the path composer 406b may determine the protocol address based on one or more of a schema for a path-based address that is compatible with the network protocol.

With respect to the method illustrated in FIG. 2, determining the first-third protocol address may include identifying a third sequence of nodes in a third network path that includes at least one of a node in the first sequence and a node in the second sequence. The first-third protocol address may be determined based on the third sequence.

Returning to FIG. 5A and FIG. 6A, the sequence 2.2.3.3 may be included in first path information that identifies a first network path and a first path-based protocol address that identifies the second node 502a2 with respect to the first node 502a1. The sequence 1.1.0.3 may be path information for a path-based address that identifies the first node 502a1 with respect to the second node 502a2. The sequence 1.1.0.3 may be included in the first path information in a data unit in addition to the sequence 2.2.3.3 as previously described.

In addition, as described above with respect to FIG. 5A and FIG. 6A, the sequence 1.2 may be included in second path information that identifies a second protocol address and a second network path that identifies the third node 502a3 with respect to the second 502a2. The sequence 0.3 may be path information for a protocol address that identifies the second node 502a2 with respect to the third node 502a3. The sequence 0.3 may be included in the second path information in the data unit in addition to the sequence 1.2 as previously described.

One or more of the path composers 406a operating in the first node 502a1 and/or a path composer 406a in the third node 502b3 may detect the sequence 2.2.3.3 and the sequence 1.2. The sequence 2.2.3.3 may be provided to the third node 502a3 by the second node 502a2, in an example, described in more detail below. The sequence 1.2 may be provided to the first node 502a1 by the second node 502a2 and/or by the third node 502a3, in an example described in more detail below. Given the two sequences, either or both of the path composers 406a in the first node 502a1 and in the third node 502a3 may determine a sequence 2.2.3.3.1.2 and/or another sequence 2.2.3.2 either or both of which may be a protocol address that, in the first scope-specific address space, identifies the third node 502a3 for nodes in the first region 510a1.

Further, the path composers component 406a respectively operating in the first node 502a1 and/or in the third node 502a3 may similarly detect the sequence 1.1.0.3 and the sequence 0.3, when included in the first path information and the second path information. Given the two sequences, either or both of the path composers 406a in the first node 502a1 and in the third node 502a3 may determine a sequence 0.3.1.1.0.3 and/or another sequence 0.1.0.3 either or both of which may be a protocol address that, in the third node-specific address space, identifies the first node 502a1 for the third node 502a3.

A path composer 406b operating in the second node 502a2, as described in more detail below, may similarly identify protocol addresses for communicating between the first node 502a2 and the third node 502a3, based on first address information and second address information as described in the preceding paragraphs.

As FIG. 6B illustrates a variant of the address representation 602a illustrated in FIG. 6A, a path composer 406a and/or a path composer 406b may include instructions to detect first and second path information to determine a protocol address in a manner analogous to that described above with respect to FIG. 5A and FIG. 6A.

As described above with respect to FIG. 5C and FIG. 6C, the sequence 101.0.1.3.2.1 may be included in first path information that identifies a protocol address that identifies the second node 502c2 with respect to the first node 502a1. The sequence may be reversed to identify 1.2.3.1.0.101 as path information for a protocol address that identifies a network path from the second node 502c1 to the first node 502c1. In addition, as described above with respect to FIG. 5C and FIG. 6C, the sequence 1.3.0.15 may be included in second path information that identifies a protocol address that identifies the third node 502c3 with respect to the second node 502a2. The sequence 3.1 may be part of a protocol address that identifies the second node 502c2 to the third node 502a3. The sequence 3.1 is included in a portion of the sequence 1.3.0.15 in reverse order.

One or more of the path composers 406a operating respectively in the first node 502c1 and/or a path composer 406a in the third node 502c3 may detect the sequence 101.0.1.3.2.1 and the sequence 1.3.0.15. The sequence 101.0.1.3.2.1 may be provided to the third node 502c3 by the second node 502c2. The sequence 1.3.0.15 may be provided to the first node 502c1 by the second node 502c2 and/or by the third node 502c3. Given the two sequences, either or both of the path composers 406a in the first node 502c1 and in the third node 502c3 may determine a sequence 101.0.1.3.2.1.1.3.0.15, and/or another sequence 101.0.3.1.2.3.0.15, either or both of which may be a path-based address that identifies the third node 502c3 with respect to the first node 502a1. Repeated path and/or hop identifiers may indicate a loop in a network path in some address representations 602 as the examples illustrates. A path composer 406a may detect loops and remove them to produce shorter protocol addresses. In other address types, loops may be detected by a path composer 406 to detect repeated pairs in hop and/or path identifiers where one identifier from a pair is from a source address and the other identifier in the pair is from a corresponding portion of a destination address.

Further, the path composers 406a respectively operating in the first node 502c1 and/or in the third node 502c3 may similarly detect the sequence 1.2.3.1.0.101 and the sequence 2.0.3.1, when included in the first path information and the second path information, respectively. Given the two sequences, either or both of the path composers 406a in the first node 502c1 and in the third node 502c3 may determine a sequence 2.0.3.1.1.2.3.1.0.101 and/or another sequence 2.0.3.2.3.1.0.101, either or both of which may be a protocol address that identifies the first node 502c1 for nodes in the third region 510c3. A path composer 406b operating in the second node 502c2, as described in more detail below, may similarly identify protocol addresses for communicating between the first node 502c2 and the third node 502c3 based on first path information and second path information as described in this and the preceding paragraphs.

As described above with respect to FIG. 5B and FIG. 6D, the sequence 151-254.151-10 may be included in first path information that identifies a first network path that identifies the second node 502b2 with respect to the first node 502b1. The sequence 10-151.254-151 may be included in the first path information as a second ordering of the identifiers in the sequence 151-254.151-10 and may be path information for a network path from the second node 502b2 to the first node 502b1, Also as described above with respect to FIG. 5B and FIG. 6D, the sequence 10-254.151-10 may be included in second path information that identifies a second network path from the second node 502b1 to the third node 502b3. The sequence 10-151.254-10 may be included in the second path information as a second ordering of the identifiers in the sequence 10-254.151-10 and may identify a network path from the third node 502b3 to the second node 502b2.

One or more of the path composers 406a operating respectively in the first node 502b1 and/or a path composer 406a in the third node 50b3 may detect the sequence 151-254.151-10 and the sequence 10-254.151-10. The sequence 151-254.151-10 may be provided to the third node 502b3 by the second node 502b2. The sequence 10-254.151-10 may be provided to the first node 502b1 by the second node 502b2 and/or by the third node 50b3. Given the two sequences, either or both of the path composers 406a in the first node 502b1 and in the third node 502b3 may determine a sequence 151-254.151-10.10-254.151-10 and/or another sequence 151-254.151-254.151-10, either or both of which may be path information that identifies a network path from the first node 502b1 to the third node 502b3 and may be identified in an address representation 602d.

Further, the path composers 406a respectively operating in the first node 502b1 and/or in the third node 502b3 may similarly detect the reverse sequence 10-151.254-151 and the reverse sequence 10-151.254-10, when included in the first address information and the second address information, respectively. Given the two sequences, either or both of the path composers 406a in the first node 502b1 and in the third node 502b3 may determine a sequence 10-151.254-10.10-151.254-151 and/or another sequence 10-151.254-151.254-151 either or both of which may be a path-based address that identifies the third node 502b3 with respect to the first node 502b1. A path composer 406b operating in the second node 502b2, as described in more detail below, may similarly identify protocol addresses for communicating between the first node 502b1 and the third node 502b3 based on first path information and second path information as described in the preceding paragraphs.

As described above, FIG. 6E illustrates that a path-based address may include portions that are not path-based. As described above with respect to FIG. 5B and FIG. 6E, the sequence 254.10 may be included in first path information that identifies a first network path that identifies the second node 502b2 with respect to the first node 502b1. The sequence 151.151 may be included in the first path information as source address information that may be path information in a protocol address that identifies the first node 502b1 with respect to the second node 502b2. In addition, as described above with respect to FIG. 5B and FIG. 6E, the sequence 254.10 may be included in second path information that identifies a second network path in a protocol address that identifies the third node 502b3 with respect to the second node 502a2. The sequence 151.10 may be included in the second path information as source address information that may be a protocol address that includes path information identifying a network path from the third network 506b3 to the second node 506b2

One or more of the path composers 406a operating respectively in the first node 502b1 and/or a path composer 406a in the third node 502b3 may determine a sequence 254.10.254.10 and/or another sequence 254.254.10 either or both of which may be a protocol address that identifies the third node 502b3 with respect to the first node 502b1. Further, the path composers 406a respectively operating in the first node 502b1 and/or in the third node 502b3 may similarly detect the sequences 151.151 and 151.10. Given the two sequences, either or both of the path composers 406a in the first node 502b1 and in the third node 502b3 may determine a sequence 151.10.151.151 and/or another sequence 151.151.151 either or both of which may be path-based addresses identify the first node 502b1 for the third node 502b3. A path composer 406 may detect the duplicate identifier 10 in first corresponding positions in the sequence, along with identifiers 254 and 151 in a second corresponding position in the sequence. The path composer 406 may also determine that all three identifiers are in the same region 506b2 where they serve as local scoped addresses. The path composer 406 may determine that the identifier 10 is unnecessary, based on the its order in both sequences with respect to other identifiers in the same scope. A path composer 406b operating in the second node 502b2, as described in more detail below, may similarly identify protocol addresses for communicating between the first node 502b2 and the third node 502b3 based on first path information and second path information as described in the preceding paragraphs

As already described above and/or below, the method illustrated in FIG. 2 may include additional aspects. In one aspect, determining the first-third protocol address may include identifying a first hop that includes a first pair of consecutive nodes in the first network path and may include identifying a second hop that includes a second pair of consecutive nodes included in the second network path. The method may further include identifying a third network path that includes at least one of the first hop and the second hop. The first-third protocol address may be determined based on the third sequence. The first-third protocol address may include a first hop identifier that identifies the first hop and/or a second hop identifier that identifies the second hop.

The first hop may be identified with respect to the first node by a first hop identifier and/or may be identified with respect to the second node by a second hop identifier. In FIG. 5C, the second hop 508c2 is identified by the hop identifier 3 by the seventh path node 504c7 and by the eighth path node 504c8 that are each included in the second hop 508c2. With respect to the second node 502c2, the second hop 508c2 may be identified by the hop identifier 1.3. In an aspect illustrated in FIG. 5B, the sixth hop 508b6 may be identified by the first path node 504b1 by the hop identifier 151-254. The sixth hop 508b6 may be identified by the second path node 504b2 by the hop identifier 254-151. The first node 502b1 may identify the sixth hop 508b6 with the hop identifier 151-254.151.254; the hop identifier 151-10.10-254.151-254; and with other sequences of hop and/or interface identifiers.

A hop identifier may be assigned to identify a hop by a pair of nodes in the hop based on a negotiation between the pair. Further, a first node and a second node in a hop may be included in the hop via a first network interface and a second network interface, respectively. The first network interface and the second network interface are included in communicatively coupling the first node and the second node when included in the hop. As described above, a hop identifier that identifies a hop to one or both nodes in the hop may include an interface identifier that identifies a network interface in one or both nodes in the hop.

A first hop identifier that identifies a first node in a hop with respect to a second node in the hop may be included in a protocol address that identifies the first node to a node in a network path that includes the second node. An identifier of a hop may be included in another identifier of the hop. The identifier may identify a network path that is included in another network path identified by the other hop identifier.

A path-based address may include a sequence of hop identifiers that, in a first order, identifies a third node with respect to a first node. The sequence of hops identifiers may be processed in second order to identify the first node with respect to the third node.

With respect to the method in FIG. 2 and as described above, a first-second protocol address that identifies the second node with respect to the first node may be determined and/or otherwise identified based on the first path information. Alternatively or additionally, a second-first protocol address that identifies the first node with respect to the second node may be determined and/or otherwise identified based on the first path information. Further, a second-third protocol address that identifies the third node with respect to the second node may be determined and/or otherwise identified based on the second path information. Alternatively or additionally, a third-second protocol address that identifies the second node with respect to the third node may be determined and/or otherwise identified based on the second path information. The first-third protocol address may be determined based on at least one of the first-second protocol address and the second-first protocol and based on at least one of the second-third protocol address and the third-second protocol address.

In an aspect of the method illustrated in FIG. 2, the first-third protocol address may be in a first scope-specific identifier space specific to a first network region that includes the first node. Refer to application Ser. No. 13/727,653 (Docket No DRV0029) filed on 2012 Dec. 27, entitled “Methods, Systems, and Computer Program Products for Identifying a Protocol address in a Scope-specific Address Space”.

A node, referred to in an aspect as a first origin node, in a network may be assigned a protocol address, of a network protocol, identifying a location of a representation of the node as an origin according to a coordinate system for a metric space. The metric space includes a network topology representing the network based on the network protocol. Another node, referred to as a second origin node, in the network may be assigned a protocol address identifying a location of a representation of the other node as an origin according to a second coordinate system for the metric space that includes the network topology representing the network. The first coordinate system includes location identifiers based on the first origin node location and the second coordinate system includes location identifiers based on the second origin node location Alternatively or additionally, a network interface of an origin node may be identified by a coordinate identifying the origin of the coordinate space in the metric space where the metric space includes a topology representing network interfaces and/or network endpoints of the network protocol.

Nodes may exchange mapping information. In an aspect, the address information may identify a mapping rule when exchanged between nodes. The mapping rule may be determined by the second node and sent to the first node. The mapping rule may include mapping information for mapping addresses from the third scope-specific address space to the first scope-specific address space. Those skilled in the art will see that given address information for protocol addresses from any two scope-specific address spaces identifying respective origin locations in a metric space including a representation of a network and given a protocol address of third node not included in a region of either of the two scope-specific address spaces, a mapping rule may be determined by a path composer component to map the protocol address of the third node in one of the two scope-specific address spaces to the other to identify the third node in the other scope-specific address space.

A Cartesian coordinate system is an exemplary address space for a Euclidean space. Another example of a geometric address space is a geospatial address space such as used currently in geo-location services. Networks have topologies that may be represented in a geo-space including locations addressed via a geometric address space. A metric space including a network topology of a network may be multi-dimensional space. For example, nodes are included in a real-world three-dimensional space that may be associated with a geospatial address space. In one aspect, locations of nodes in a network topology in a metric space may be located based on any suitable metric. Exemplary metrics may measure and/or otherwise may be based on physical distance in the real world between nodes, data transmission times, energy unitization, network congestion, latency, and the like. Exemplary metric spaces include non-Euclidean spaces as well as Euclidean spaces.

A first node, a second node, and a third node may be represented in a metric space. A first path in the metric space connecting the representation of the first node to the representation of the second node may be identified based on a first path location identifier that identifies a location in the first path of a representation of a node, a network interface in the node, a NIC in the network interface, and/or a hop that includes the node in a first network path communicatively coupling the first node and the second node. A second path in the metric space connecting the representation of the second node to the representation of the third node may be identified based on a second path location identifier that identifies a location in the second path of a representation of a node, a network interface in the node, a NIC in the network interface, and/or a hop that includes the node in a second network path communicatively coupling the second node and the third node. A first-third protocol address, that identifies the third node with respect to the first node for a network protocol, may be determined based on the first path location identifier and/or the second path location identifier. The first-third protocol address may include the first path location identifier and/or the second path location identifier.

The first path location identifier may be a relative identifier that identifies the representation in the first path relative to a first location identifier identifying a first location, in the metric space, that includes a representation of the first node or relative to a second location identifier identifying a second location, in the metric space, that includes a representation of the second node. Analogously, the second path location identifier may also be a relative identifier that identifies the representation in the second path relative to the second location identifier or relative a third location identifier identifying a third location, in the metric space, that includes a representation of the third node. The first-third protocol address may be determined based on at least one of the first path location identifier and the third path location identifier. The first-third protocol address may be relative identifier that identifies the third node relative to the first node. The first-third protocol address may include a third location identifier that identifies the third location relative to the first location identifier.

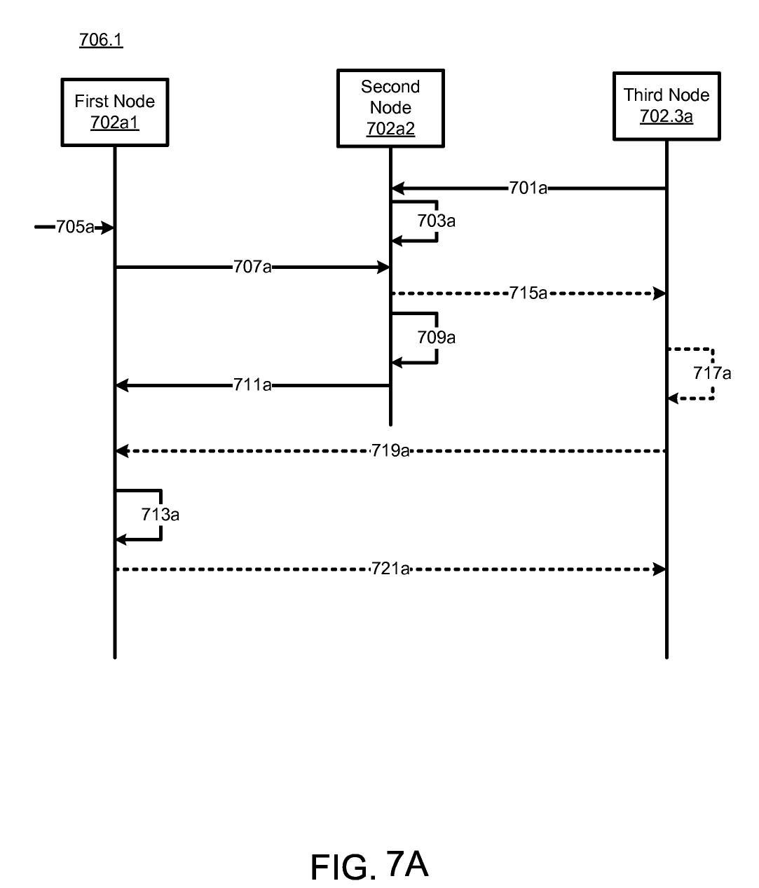

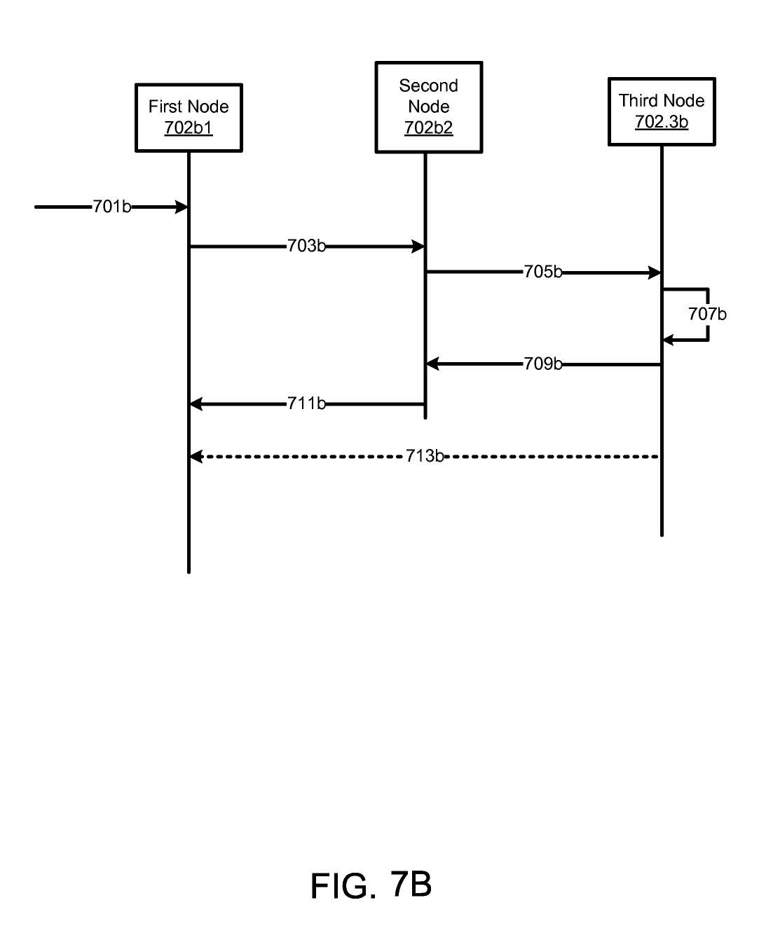

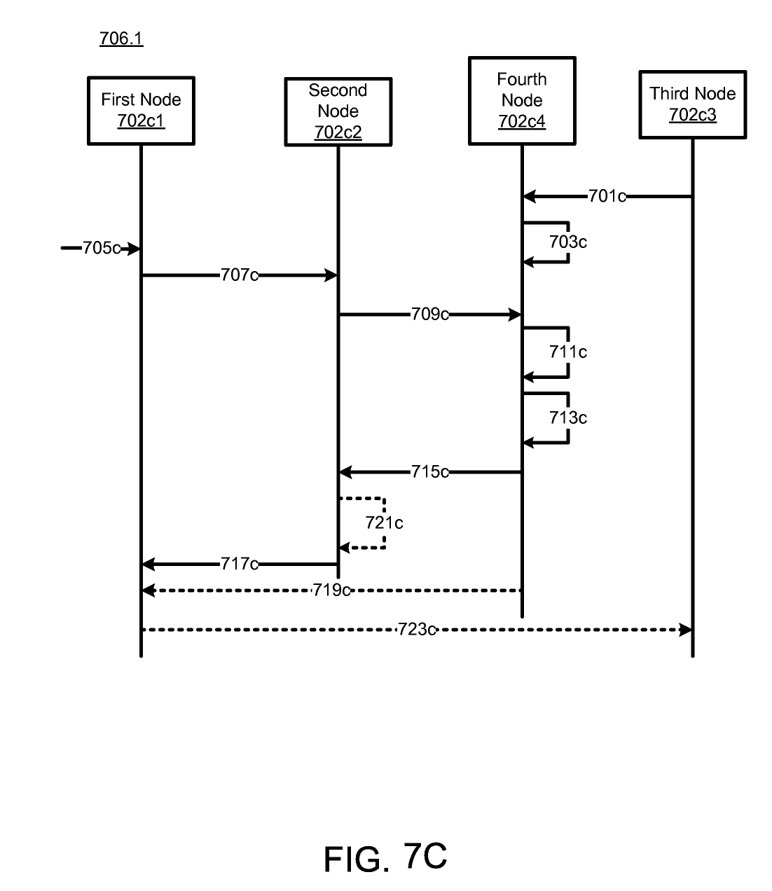

FIGS. 7A-C illustrate respective data exchanges between nodes in different aspects of the method illustrated in FIG. 2. FIG. 7A illustrates an exemplary data exchange in an aspect of the method illustrated in FIG. 2 that includes communicating, via the network by a first node to a second node, a first data exchange, wherein first path information is detected based on a data unit included in the first data exchange. A second data exchange may be received, via the network, in response to the first message. The second path information may be detected based on receiving a data unit included in the second data exchange.

In FIG. 7A, data is exchanged between a first node 702a1, a second node 702a2, and a third node 702a3 operating to resolve a symbolic identifier for the third node 702a3 to a path-based address for a network communication between the first node 702a1 and the third node 702a3. The nodes in FIG. 7A may represent nodes in networks described above illustrated in FIGS. 5A-C. In FIG. 7A, in one aspect, the first node 702a1 is and/or otherwise provides an adaptation of the execution environment 401a including an NDS client component 419a. The second node 702a2, in the aspect, may host an NDS service. The third node 702a3 may host an NDS client compatible with the NDS service in the second node 702a2.

FIG. 7A illustrates a first data exchange 701a including a symbolic identifier. Some or the entire data exchange may identify second path information and/or may be sent in one or more data units including and/or otherwise identifying the second path information in an address representation, such as illustrated in FIGS. 6A-E. The second path information may identify a protocol address of the second node 702a2 with respect to the third node 702a3. The first data exchange 701a may include a request to register the symbolic identifier of the third node 702a3 with an NDS service operating in the second node 702a2. The first data exchange 701a may be sent by an NDS client component in the third node 702a3 via a network stack. The first data exchange 701a may be received by the second node 702a2 via a compatible network stack and an NDS protocol component operating in the second node 702a2. A second data exchange 703a in FIG. 7A illustrates an information exchange in the second node 702a2 included in creating an association between the symbolic identifier and the second path information. The registration request in the first data exchange 701a may be provided to the NDS service in the second node 702a2 to create and/or update a record associating the symbolic identifier and the second path information.

FIG. 7A illustrates the first node 702a1 as a recipient in a third data exchange 705a identifying the symbolic identifier that identifies the third node 702a3. The third data exchange 705a may be exchanged within the execution environment 401a of the first node 702a1 as a request from a communications application 403a to the NDS client 419a. The request may be directly communicated and/or indirectly communicated, for example via a sockets component 407a. The NDS client component 419a may interoperate with an NDS protocol component 421a to generate an NDS request to send to an NDS service to resolve the symbolic identifier.

The NDS protocol component 421a may provide the NDS protocol request to the network stack 405a to send the request illustrated by a fourth data exchange 707a to deliver the request to the NDS service in and/or otherwise provided at least in part by the second node 702a2. The fourth data exchange 707a may include one or more data units generated by a packet generator component 433a interoperating with a path detector component 402a. The one or more data units may include first path information identified by the path detector component 402a to identify the second node 702a2 in an address representation in the one or more data units. The first path information may identify a protocol address that identifies the second node 702a2 in a data unit sent from the first node 702a1.

The request in the fourth data exchange 707a may be received by the second node 702a2. A fifth data exchange 709a illustrates an information exchange within the second node 702a2 included in locating the second path information associated with the symbolic identifier received in the first data exchange 701a. The second path information located may be returned to the first node 702a1 by the second node 702a2 via a sixth data exchange 711a. The sixth data exchange 711a may include one or more data units received by a packet detector component 435a. In an aspect, path information may be detected in and/or otherwise based on a data unit received in the sixth data exchange 711a and used as first path information in addition to or instead of the first path information associated with the fourth data exchange 707a. The second path information may be detected by an address space director component 404a that manages path information from various nodes in the network. The address space director component 404a may receive the second path information via a path detector component 402a interoperating with the packet detector component 435a in processing a data unit and/or a message included in the data exchange 711a. Both the first path information and the second path information may be provided to a path composer 406a.

In an aspect, the fifth data exchange 709a may be included in locating the second path information to resolve the identifier by a path composer component in the second node 702a2. The sixth data exchange 711a may include a path-based address that identifies the third node 702a3 to the first node 702a1. The first node 702a1 may determine the protocol address in response to receiving the protocol address in the sixth data exchange 711a. In another aspect, the fifth data exchange 709a may be included in locating the second path information to determine third path information based on the second path information and the first path information received from the first node 702a1. The third path information may identify a network path form the first node 702a1 to the third node 702a3 and/or a network path from the third node 702a3 to the first node 702a1. The third path information may be received by the first node 702a1 in the sixth data exchange 711a. The first node 702a1 may determine the protocol address based on the third path information.

A seventh data exchange 713a illustrates an exchange of information within the first node 702a1 included in determining a protocol address based on the first path information detected by the path detector component 402a and the second path information detected by the address space director 404a. The seventh data exchange 713a may illustrate a communication within the first node 702a1 where the path composer 406a receives the first path information and the second path information, third path information, and/or one or more path-based protocol addresses as described above to determine a path-based address that identifies a network interface of the third node 702a3 with respect to the first node 702a1.

An eighth data exchange 715a, a ninth data exchange 717a, and a tenth data exchange 719a illustrate data exchanges that may be exchanged as an alternative to or in addition to one or more of the first data exchange 701a, the second data exchange 703a, the fifth data exchange 709a, and the sixth data exchange 711a. In an aspect, in response to receiving the fourth data exchange 707a, the second node 702a2 may relay the symbolic identifier, along with the first path information received in one or more data units included in receiving the fourth data exchange 707a, in the eighth data exchange 715a. The eighth data exchange 715a may be sent based on a path-based address that identifies the third node 702a3 with respect to the second node 702a2.

For example, a data unit included in sending the eighth data exchange 715a may include second path information based on the protocol address identifying the third node 702a3. The ninth data exchange 717a illustrates an information exchange in the third node 702a3 included in determining a protocol address that identifies a network path from the third node 702a3 to the first node 702a1 based on the first path information and on the second path information respectively included in data units included in receiving the eighth data exchange 715a and in sending the first data exchange 701a. The tenth data exchange 719a illustrated may include one or more data units sent from the third node 702a3 to the first node 702a1. The one or more data units may include an address representation that includes path information identifying the protocol address determined by the third node 702a3. The tenth data exchange 719a may be received by the first node 702a1. The protocol address identifying the network path from the third node 702a3 to the first node 702a1 may be detected by the address space director component 404a of the first node 702a1 as described above as second path information for the first node 702a1. The first path information and the second path information for the first node 702a1 may be received by the path composer component 406a as illustrated by the seventh data exchange 713a to determine a protocol address that identifies the third node 702a3 for the first node 702a1 to resolve the symbolic identifier. The protocol address determined by the path composer 406a may be provided to a communications application 403a and/or a component of the network stack 405a to send an eleventh data exchange 721a to the third node 702a3 from the first node 702a1 based on the determined protocol address that resolves the symbolic identifier.

In another aspect, the fourth data exchange 707a may include one or more data unit in sending data to the NDS service in the second node 702a2 via a proxy. A data exchange may be sent by the first node 702a1 to a proxy node where the data exchange includes a request to resolve a symbolic identifier, but the data exchange does not include a protocol address and/or otherwise path information that identify the second node 702a2 with respect to the first node 702a1. The proxy node may forward the request via the fourth data exchange 707a to the second node 702a2 including the NDS service. The proxy node may be configured with another protocol address that identifies a network path from the proxy node to the second node 702a2 enabling the proxy node to forward the request in the fourth data exchange 707a to the second node 702a2 from the proxy node. The proxy node may be a path node in a network path including the first node 702a1 and the second node 702a2 as path end nodes. The request from the first node 702a1 may identify the second node 702a2 to the proxy node by identifying a naming domain that includes the symbolic identifier.

In yet another aspect, the fourth data exchange 707a may include data to be delivered to the third node 702a3. In FIG. 7A, the eighth data exchange 715a may deliver the data to the third node 702a3. The data in the fourth data exchange 707a may include a request for the third node 702a3 to send data in a data exchange to the first node 702a1. The tenth data exchange 719a may include data sent in response to the data from the first node 702a1. The data sent to the third node 702a3 may include authorization information granting the third node 702a3 permission to send a data exchange to the first node 702a1.

Once the first node 702a1 resolves a symbolic identifier it may cache and/or otherwise store an association between the symbolic identifier and the determined protocol address for later use. Note that a symbolic identifier may be resolved to one or more protocol addresses from the same scope-specific address space and/or different scope-specific address spaces.

FIG. 7B illustrates an exemplary data exchange in an aspect of the method illustrated in FIG. 2 that includes a third node detecting the first path information by receiving, via the network from the second node, a first data unit identifying the first path information. The third node may further detect the second path information based on receiving the first data unit.

FIG. 7B illustrates data exchanges among a first node 702b1, a second node 702b2, and a third node 702b3 in resolving a symbolic identifier for the third node 702b3 to a protocol address. The protocol address may be used for an exchange between the first node 702b1 and the third node 702b3 via a network. The nodes may be any nodes in the respective networks 500 illustrated in FIGS. 5A-C.

With respect to FIG. 7B, the third node 702b3 may be included in and/or otherwise provide an adaptation, analog, and/or instance of the execution environment 401a including an NDS client component 419a. The second node 702b2, in the aspect, may host and/or otherwise may be included in providing an NDS service. The first node 702b1 may host and/or otherwise may be included in providing an NDS client compatible with the NDS service in the second node 702b2. FIG. 7B illustrates a first data exchange 701b including a symbolic identifier to resolve to a protocol address for communicating between the first node 702b1 and the third node 702b3. An NDS client in the first node 702b1 may send a second data exchange 703b via an NDS protocol to an NDS service operating in the second node 702b2. The second data exchange 703b may include and/or may be sent via one or more data units including first path information identifying a protocol address that identifies a first network path from the first node 702b1 to the second node 702b2. Alternatively or additionally, the first path information may identify a network path from the second node 702b2 to the first node 702b1. For example, the second data exchange 703b may be sent in one or more data units that include a protocol address of the second node 702b2 sent from the first node 702b1 as a destination protocol address and/or may include a source protocol address that identifies the first node 702b1 as the source of the data to the second node 702b2. The second data exchange 703b includes the symbolic identifier of the third node 702b3 in a request to resolve the symbolic identifier to a protocol address.

In an aspect, the second node 702b2 may relay the request to resolve the symbolic identifier to the third node 702b3. A third data exchange 705b illustrates a relaying of the request to resolve the symbolic identifier. The second node 702b2 may also include, in the third data exchange 705b and/or in a data unit included in sending the third data exchange 705b, the first path information included in and/otherwise detected based on the second data exchange 703b. Further, the third data exchange 705b may include and/or may be sent via one or more data units that include second path information. The second path information may identify a protocol address that identifies the third node 702b3 to the second node 702b2. Alternatively or additionally, the second path information may identify a protocol address that identifies the second node 702b2 to the third node 702b3.

A data unit included in the third data exchange 705b may be received by the packet detector component 435a illustrated in FIG. 4A in the execution environment 401a of the third node 702b3. A path detector component 402a may be invoked to detect the first path information in the third data exchange 705b and/or in the data unit included in the third data exchange 705b. The path detector component 402a may be invoked by an NDS client component 419a in response to receiving the request in the third data exchange 705b. In an aspect, an NDS client component 419a may include an adaptation of a path detector component. The second path information in the one or more packet headers may be detected as second path information by an address space director component 404a interoperating with the NDS client component 419a.

A fourth data exchange 707b illustrates an exchange of data in the third node 702b3 included in providing the first path information and the second path information to a path composer 406a to determine a protocol address that resolves the symbolic identifier. In various aspects, a path composer 406a may determine a path-based address that identifies a network path from the third node 702b3 to the first node 702b1 and/or a path-based address that identifies a network path from the first node 702b1 to the third node 702b3. The NDS client component 419a may send one or more data units in a fifth data exchange 709b identifying the determined protocol address to the second node 702b2, in response to the request received in the third data exchange 705b. The second node 702b2 may send the determined protocol address in a sixth data exchange 711b in response to the request received in the second data exchange 703b. The determined protocol address, in the aspect, resolves the symbolic identifier to the scope-specific address identifying the first node 702b1. The first node 702b1 may address a data unit in a data exchange (not shown) to the third node 702b3 by including the protocol address in an address representation in one or more data units of a network protocol included in the data exchange.

Alternatively or additionally, the path composer 406a operating in the third node 702b3 may determine a protocol address that identifies a network path between the first node 702b1 and the third node 702b3. The NDS client component 419a may send data in a seventh data exchange 713b to the first node 702b1 by including a representation of the determined protocol address as a destination protocol address and/or as a source protocol address based on the address determined and the type of address representation. The protocol address and/or path information may be in the seventh data exchange 713b and/or one or more data units included in the seventh data exchange 713b. The seventh data exchange 713b may occur in response to the request received in the third data exchange 705b and, indirectly, in response to the request received by the second node 702b2 in the second data exchange 703b.

In an aspect, the third data exchange 705b from the second node 702b2 may include data sent by the first node 702b1 in the second data exchange 703b to the third node 702b3. The data in the third data exchange 705b may include a request for the third node 702b3 to send data in a data exchange to the first node 702b1. The data in the third data exchange 705b received by the third node 702b3 may include authorization information granting the third node 702b3 permission to send data in a data exchange to the first node 702b1. One or more of the fifth data exchange 709b and the seventh data exchange 713b may include authorization information from the first node 702b1 authorizing the third node 702b3 to send data to the first node 702b1.

FIG. 7C illustrates an exemplary data exchange in an aspect of the method illustrated in FIG. 2. With respect to FIG. 2 the method may include the second node receiving a first data exchange via one or more data units from the first node that identify the first path information that is detectable by the second node. In FIG. 7C, data exchanges involving a first node 702c1, a second node 702c2, and a third node 702c3 are illustrated that are included in resolving a symbolic identifier for the third node 702c3 to a protocol address for a communication between the first node 702c1 and the third node 702c3 via a network. The nodes in FIG. 7C may be any nodes in the respective networks 500.

With respect to FIG. 7C, in one aspect, the second node 702c2 is and/or otherwise provides an adaptation of execution environment 401b including an NDS service component 403b. The first node 702c1 may host an NDS client component, as may the third node 702c3. FIG. 7C illustrates the second node 702c2 included in an NDS system and illustrates a fourth node 702c4 as another node in the NDS system hosting another NDS service.

FIG. 7C illustrates a first data exchange 701c including a symbolic identifier sent from the third node 702c3. The first data exchange 701c and/or a data unit included in sending the first data exchange 701c may include second path information. The second path information may include and/or otherwise may be based on a protocol address. The protocol address identifies the fourth node 704c4 in a data unit sent from the third node 702c3. The first data exchange 701c may be exchanged to register the symbolic identifier of the third node 702c3 with a NDS system. The NDS system including the second node 702c2 and the fourth node 702c4 may route the request to a node including an NDS service responsible for the symbolic identifier based on a structure of a name space managed by the NDS system.

In FIG. 7C, the fourth node 702c4 may manage a domain in the NDS system that includes the symbolic identifier of the third node 702c3. The first data exchange 701c may be received by the fourth node 702c4 via a network stack 405b and an NDS protocol component 421b operating in the fourth node 702c4. The second path information received in and/or otherwise with the first data exchange 701c and the symbolic identifier may be provided by the NDS protocol component 421b to a client communication component 429b in the fourth node 702c4.

A second data exchange 703c in FIG. 7C illustrates an information exchange in the fourth node 702c4 included in creating and/or updating an association between the symbolic identifier and the second path information detected in the first data exchange 701c. The registration request in the data exchange 701c may be detected by the client communication component 429b. An address space director component 404b in the fourth node 702c4 may receive and/or otherwise detect the symbolic identifier and the second path information. The address space director component 404b may create and/or update a record associating the symbolic identifier and the second path information stored in an ID-address data store 425b in the execution environment 401b of the fourth node 702c4.

FIG. 7C illustrates a first node 702c1 receiving data via a third data exchange 705c identifying the symbolic identifier, such as a DNS name, registered by the third node 702c3. The third data exchange 705c may include a request to an NDS client in the first node 702c1. The NDS client component in the first node 702c1 may send data via a fourth data exchange 707c to an NDS service in the NDS system to resolve the symbolic identifier. The request in the fourth data exchange 707c may be received by the NDS service 403b in the second node 702c2. Data in the fourth data exchange 707c may include and/or may be received along with first path information identifying a protocol address and/or a network path that identifies the second node 702c2 to the first node 702c1. The request in the fourth data exchange 707c may be received by the client communications component 429b in the second node 702c2 and routed to an address space director component 404b in the second node 702c2.

The address space director component 404b may determine that the symbolic identifier is not included in a domain of the symbolic name space represented by the second node 702c2. The address space director component 404b may additionally determine that the symbolic identifier is not included in a cache illustrated by DB cache 427b for storing information received from other nodes in the NDS system, such as the fourth node 702c4. In response, the address space director component 404b in the second node 702c2 may interoperate with a system communication component 431b in the second node 702c2 to send data in a fifth data exchange 709c including the symbolic identifier for routing by the NDS system to a node that represents the domain of the symbolic identifier, such as the fourth node 702c4.

The fourth node 702c4 may receive data in the fifth data exchange 709c via a system communications component 431b included in the fourth node 702c4. The request may be provided to the address space director component 404b in the fourth node 702c4 to resolve the symbolic identifier included in a domain managed by the fourth node 702c4. The fifth data exchange 709c may include one or more data units that include respective path information including additional first path information that identifies a protocol address that identifies the fourth node 702c4 to the second node 702c2.

A sixth data exchange 711c illustrates an exchange of information in the execution environment 401b of the fourth node 702c4 to lookup the path information, received in the first data exchange 701c, from the ID-address data store 425b based on the symbolic identifier. In an aspect, a path detector component 402b in the fourth node 702c4 may detect the additional first path information associated with the fifth data exchange 709c. In a further aspect, the first path information associated with the fourth data exchange 707b may be relayed to the fourth node 702c4 via the fifth data exchange 709c to detect by the path detector component 402a in the fourth node 702c4. The first path information and the additional first path information together may identify a protocol address that identifies the fourth node 702c4 to the first node 702c1 and/or vice versa.

Alternatively or additionally, the first protocol address may identify a protocol address that identifies the first node 702c1 with respect to the second node 702c2 and/or the additional first path information may identify a protocol address that identifies the second node 702c2 with respect to the fourth node 702c4. Based on first path information and the additional first path information, a protocol address may be determined that identifies the first node 702c1 to the fourth path node 702c4 and/or vice versa.

A seventh data exchange 713c illustrates an exchange of information in the fourth node 702c4 included in providing first path information, the additional first path information, and the second path information to a path composer 406b in the fourth node 702c4. The path composer 406b, in an aspect, may determine a protocol address that identifies the third node 702c3 to the first node 702c1 and/or a protocol address that identifies the first node 702c1 to the third node 702c3. The path composer 406b in the fourth node 702c4 may send the determined protocol address(es) via an eighth data exchange 715c to the second node 702c2 to relay to the first node 702c1 via a ninth data exchange 717c sent by the second node 702c2 in response to the fourth data exchange 707c to resolve the symbolic identifier. Alternatively or additionally, the fourth node 702c4 may send the determined protocol address(es) to the first node 702c1 in a tenth data exchange 719c addressed to the first node 702c1 based on the protocol address described above that identifies a network path from the fourth node 702c4 to the first node 702c1.

In another aspect, the path composer 406b in the fourth node 702c4 may determine a protocol address of the third node 702c3 based on the path information received in and/or with the first data exchange 701c and based on path information received in and/or with the fifth data exchange 709c where the determined protocol address identifies a network path between the second node 702c2 and the third node 702c3 or between the fourth node 702c4 and the third node 702c3. More than one protocol address may be determined. The path composer 406b in the fourth node 702c4 may send the determined protocol address(es) and/or corresponding path information to the second node 702c2 in and/or along with the eighth data exchange 715c.

The second node 702c2 may provide path information received in the fourth data exchange 707c, as first path information, and may provide second path information based on the path information identified in and/or based on the eighth data exchange 715c to the path composer 406b in the second node 702c2. This interoperation with the path composer 406b is illustrated by an eleventh data exchange 721c. The path composer 406b in the second node 702c2 may determine a protocol address that identifies a network path from the first node 702c1 to the third node 702c3 and/or may determine a protocol address that identifies a network path from the third node 702c3 to the first node 702c1. The second node 702c2 may send the one or more determined protocol addresses in the ninth data exchange 717c according to the aspect, in response to the fourth data exchange 707c to resolve the symbolic identifier.

In yet another aspect, the seventh data exchange 713c in FIG. 7C may not occur. That is the fourth node 702c4 may send path information received in the first data exchange 701c to the second node 702c2 via the eighth data exchange 715c. In another aspect, the path information may also include path information that is received in the fifth data exchange 709c and/or that is otherwise determined in response to sending data in the fifth data exchange 709c. The second node 702c2 may provide path information received in the fourth data exchange 707c, as first path information, and may provide second path information included in and/or determined in response to the eighth data exchange 715c1 and/or the fifth data exchange 709c to the path composer 406b in the second node 702c2. This interoperation with the path composer is illustrated by the eleventh data exchange 721c.

As illustrated by fourth data exchange 707c and fifth data exchange 709c in FIG. 7C, first path information identifying a network path form first node 702c to fourth node 702c may be received, based on a second-fourth protocol address of the network protocol that identifies the fourth node 704c4 to the second node 704c2 and/or identifies the second node 704c2 to the fourth node 704c4; and may be received based on a first-second protocol address of the network protocol that identifies the first node 702c1 to the second node 702c2 and/or identifies the second node 702c2 to the first node 702c1.

The path composer 406b in the second node 702c2 may determine a protocol address that identifies a network path from the first node 702c1 to the third node 702c3 and/or may determine a protocol address that identifies a network path from the third node 702c3 to the first node 702c1. The second node 702c2 may send a data exchange, to the first node 702c2 in response to the fourth data exchange 707c. The data exchange sent in response may include one or more of the determined addresses. In FIG. 7C, the second node 702c2 may send the determined protocol addresses in the ninth data exchange 717c according to the aspect, in response to the fourth data exchange 707c to resolve the symbolic identifier.

A data exchange 723c illustrates that the first node 702c1 may send a data exchange to the third node 703c3 identified by the determined protocol address received from the second node 702c2 and/or the fourth node 702c4 as described in various aspects above.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that operate to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable medium and execute the instructions for carrying out the described methods. A non-exhaustive list of conventional exemplary non-transitory computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for identifying a protocol address based on path information, the method comprising:
detecting first path information that identifies a first sequence of nodes in a first network path for transmitting data between a first node and a second node in a network;
detecting second path information that identifies a second sequence of nodes in a second network path for transmitting data between the second node and a third node in the network; and
determining, based on the first path information and the second path information, a first-third protocol address that identifies, according to a network protocol, the third node to the first node for transmitting data from the first node to the third node,
wherein performing at least one element identified as comprising the method includes execution of an instruction by a processor.

2. The method of claim 1 wherein determining the first-third protocol address includes determining the first-third protocol address by at least one of one of the first node, the second node, and the third node.

3. The method of claim 1 wherein the first-third protocol address includes at least one of a first hop identifier for a first hop in the first network path and a second hop identifier for a second hop in the second network path.

4. The method of claim 3 wherein the first hop is identified with respect to the first node by the first hop identifier and the second hop is identified with respect to the second node by the second hop identifier.

5. The method of claim 3 wherein the first hop includes a first hop node and a second hop node in a pair of nodes communicatively coupled via a first network interface in the first hop node and via a second network interface in the second hop node and the first hop identifier includes at least one of a first interface identifier and a second interface identifier respectively identifying the first network interface and the second network interface to at least one of the first hop node and the second hop node.

6. The method of claim 3 wherein the first hop identifier is included in a third hop identifier that identifies the first hop with respect to the first node, the third hop identifier identifies a protocol address of the network protocol that identifies a node in the first hop to the first node.

7. The method of claim 1 wherein the first-third protocol address includes a sequence of hop identifiers in an identifiable first order

8. The method of claim 7 wherein the sequence of hop identifiers, in a second identifiable order, identifies the first node to the third node.

9. The method of claim 1 further includes:
identifying based on the first path information at least one of a first-second protocol address of the network protocol that identifies the second node to the first node and a second-first protocol address of the network protocol that identifies the first node to the second node;
identifying based on the second path information at least one of a second-third protocol address of the network protocol that identifies the third node to the second node and a third-second protocol address of the network protocol that identifies the second node to the third node; and
determining the first-third protocol address based on at least one of the first-second protocol address and the second-first protocol and based on at least one of the second-third protocol address and the third-second protocol address.

10. The method of claim 1 wherein the first node, the second, and the third node are represented in a metric space and determining the first-third protocol address includes:
Identifying, based on the first path information, a first path location identifier that identifies a first path location, in the metric space, of a representation of a node in the first network path;
identifying, based on the second path information, a second path location identifier that identifies a second path location, in the metric space, of a representation of a node in the second network path; and
determining, based on at least one of the first path location identifier and the second path location identifier, the first-third protocol address.

11. The method of claim 1 further includes receiving, based on a second-fourth protocol address of the network protocol that identifies the second node to a fourth node in the first network path, the first path information, wherein the first path information is based on the second-fourth protocol address and a first-fourth protocol address of the network protocol that identifies the fourth node to the first node.

12. The method of claim 1 further includes:
receiving a request to resolve a symbolic identifier for the third node to a protocol address that, according to the network protocol, identifies the third node to the first node; and
determining the first-third protocol address in response to receiving the request.

13. The method of claim 12 further includes resolving the symbolic identifier to the first-third protocol address in response to receiving the request.

14. The method of claim 13 further includes transmitting a data unit of the network protocol, based on the first-third protocol address, from the first node to the third node in response to resolving the symbolic identifier.

15. The method of claim 1 further includes:
receiving, via the network by the second node from the first node, a first message based on the first path information;
detecting the first path information in response to receiving the message;
receiving, based on the second path information via the network by the second node from the third node, a second message; and
sending, by the second node, the first-third protocol address to the first node, in response to receiving the second message;

16. The method of claim 15 wherein the second message includes the second path information.

17. The method of claim 15 wherein the second message includes a symbolic identifier of the third node.

18. The method of claim 15 wherein the first message includes a symbolic identifier of the third node.

19. A system for identifying a protocol address based on path information, the system comprising:
a path detector component that during operation of the system is included in detecting first path information that identifies a first sequence of nodes in a first network path for transmitting data between a first node and a second node in a network;
an address space director component that during operation of the system is included in detecting second path information that identifies a second sequence of nodes in a second network path for transmitting data between the second node and a third node in the network;
a path composer component that during operation of the system is included in determining, based on the first path information and the second path information, a first-third protocol address that identifies, according to a network protocol, the third node to the first node for transmitting data from the first node to the third node; and
a processor, wherein at least one of the path detector component, the address space director component, and the path composer component includes an instruction that is executed by the processor during operation of the system.

20. A non-transitory computer-readable medium embodying a computer program, executable by a machine, for identifying a protocol address based on path information, the computer program comprising executable instructions for:
detecting first path information that identifies a first sequence of nodes in a first network path for transmitting data between a first node and a second node in a network;
detecting second path information that identifies a second sequence of nodes in a second network path for transmitting data between the second node and a third node in the network; and
determining, based on the first path information and the second path information, a first-third protocol address that identifies, according to a network protocol, the third node to the first node for transmitting data from the first node to the third node.
